(19) United States
(12) Patent Application Publication
(10) Pub. No.: US 2024/0046294 A1
(43) Pub. Date: Feb. 8, 2024

(54) Continuous Order Book Systems and Methods

(71) Applicant: Melange Technologies, Inc., Brooklyn, NY (US)

(72) Inventors: Joshua Beck, Brooklyn, NY (US); Kenneth Noble, Brooklyn, NY (US); Glenn Yu, Brooklyn, NY (US)

(21) Appl. No.: 18/362,315

(22) Filed: Jul. 31, 2023

Related U.S. Application Data
(60) Provisional application No. 63/394,986, filed on Aug. 4, 2022.

(51) Int. Cl. G06Q 30/0201

(52) U.S. Cl. CPC G06Q 30/0206

(57) ABSTRACT

Systems and methods for operating a continuous order book for a market for wagers on the outcomes of future events, described elsewhere as a prediction market, include adjusting a market price for an item based on unmatched orders to buy and sell the item, wherein buyers and sellers trade the item at a prevailing single current market price as determined by the order book. The current market price changes according to the number, volume, and rate of unmatched outstanding orders, which will eventually be filled at a new current market price when a counterparty submits an opposing order. In some embodiments, the item is a financial instrument, like a swap, equity, debt, or derivative.

### CROSS-REFERENCE TO RELATED APPLICATIONS

This application claims priority to U.S. Provisional App. 63/394,986, titled “Continuous Order Book Systems and Methods,” filed on Aug. 4, 2022. The entire contents of U.S. Provisional App. 63/394,986 are incorporated herein by reference.

### SUMMARY

Financial and other markets match buyers and sellers at agreed upon prices. In order to ensure that traders and/or other market participants have a counterparty with whom to trade, most markets using a central limit order book (the most common contemporary market design) depend upon large financial firms known as market makers. Market makers consistently stream prices at which they are willing to buy (the bid) or sell (the offer) a given asset or item at which market participants (sometimes referred to as traders or users herein) may buy or sell the item.

When markets for a certain asset or item grow more volatile, uncertain, or have a high proportion of well-informed traders (a “well informed” trader is someone who trades with the reasonable expectation that they will make a profit at the expense of the market maker), market makers are forced to charge wider bid-ask spreads for that asset or item. A market maker's bid-ask spread is the difference between the lowest price the market maker is willing to sell the asset for and the highest price the market maker is willing to buy the asset for. The spread functions as a fee for the trade paid to the market maker by the market maker's counterparties, and the size of the spread (i.e., the amount of the difference between the market maker's ask price and the market maker's bid price) corresponds to the size of the fee. As a result of market makers charging wider bid-ask spreads, traders end up getting worse prices, i.e., traders end up paying more to the market maker on average per trade. Wider spreads can lead to low participation on exchanges and eventually the non-existence of functional markets on particular assets.

Systems and methods of operating an order book are disclosed herein that promote additional market liquidity for low-volume and high-volatility markets. In some embodiments, the method comprises providing a current market price for an item (e.g., by transmitting data comprising the current market price to market participants in response to a query or other request from the market participant), wherein the continuous order book is configured to change and/or otherwise update the current market price over time based at least in part on data contained within the continuous order book itself. In operation, the continuous order book is configured for matching orders to buy the item with orders to sell the item at the current market price that the continuous order book has determined and provided to the market participants.

The systems and methods disclosed herein rely on a new type of order, referred to herein as a continuous order, to facilitate the operation of the new type of order book, referred to herein as the continuous order book. In this disclosure the term “continuous order book” and/or “continuous order book system” includes data (i.e., active orders) contained in the order book as well as other software and computing hardware required to operate the continuous order book, including the hardware and software required to determine market (or strike) prices, hardware and software required to transmit (or at least initiate the transmission of) market (or strike) prices to market participants, hardware and software to receive and process buy and sell orders from market participants, and so on. In this manner, some embodiments of the “continuous order book” and/or “continuous order book system” disclosed and described herein is and/or comprises a networked computing system configured to perform one or more (or all) of the continuous order book features and functions described herein.

A continuous order is an order to buy (or sell) an item at the current market price (or current strike price in some embodiments) set by the continuous order book itself rather than a market price (or strike price) set by a market maker. Prices on outstanding continuous orders move with changes in the current market price. The continuous order book may change the current market price (or strike price in some embodiments) according to any number of factors, but in the primary configuration, changes in price are determined by unmatched outstanding volume of orders contained in the continuous orderbook, i.e., the current market (or strike) price is based at least in part on how many unmatched buy (or bid) and sell (or ask) orders are in the continuous order book. The continuous order book systems and methods disclosed herein allow market makers to see outstanding orders before accepting them rather than continually streaming quotes as in traditional order book systems. As a result, a market maker that operates a continuous order book as described herein is able to offer significant price improvement to all market participants (i.e., the bid-ask spread on items can be lower) as compared to a market maker that operate a traditional order book.

As explained herein, the continuous order book matches received continuous orders to buy an item (i.e., continuous buy orders) with suitable orders (including other types of orders described herein) to sell the item, and the continuous order book matches received continuous orders to sell an item (i.e., continuous sell orders) with suitable orders to buy the item. In operation, the continuous order book matches a continuous buy order received from one market participant with one or more suitable sell orders received from one or more other market participants as described herein. Similarly, the continuous order book matches a continuous sell order received from one market participant with one or more suitable buy orders received from one or more other market participants as described herein. Thus, in some embodiments described herein, individual market participants trade directly with each other in a peer-to-peer manner. By contrast, in traditional systems, market participants trade with a market maker who acts as an intermediary between individual market participants.

In operation, the disclosed methods comprise a continuous order book receiving a continuous buy or sell order for the item from a market participant, e.g., by receiving one or more data messages corresponding to the buy or sell order from the market participant. In some embodiments, the items traded via the continuous order book may be financial instruments, such as equities, debt, currencies, or derivatives contracts, or any asset or service that could be described as a financial instrument, whether or not formally registered as such.

Additionally, the methods further comprise, after the continuous order book has received a continuous buy order for the item, the continuous order book determining whether the continuous order book contains a suitable sell order to match with the received continuous buy order. As mentioned above, a continuous buy order is an offer to purchase the item at any market price advertised by the order book. When the continuous order book contains a suitable sell order to match with the received continuous buy order, the method comprises the continuous order book matching the received continuous buy order with the suitable sell order. When the continuous order book does not contain a suitable sell order to match with the received continuous buy order, the method comprises the continuous order book (i) storing the received continuous buy order in the continuous order book for matching with a suitable sell order in the future and (ii) considering the stored received continuous buy order when the continuous order book determines whether to increase the current market price of the item to encourage sell orders.

The methods also comprise the continuous order book receiving a continuous sell order from a market participant, e.g., by receiving one or more data messages corresponding to the continuous sell order from the market participant. After receiving a continuous sell order, the method comprises the continuous order book determining whether the continuous order book contains a suitable buy order to match with the received continuous sell order, wherein a continuous sell order is an offer to sell the item at any market price advertised by the continuous order book. When the continuous order book contains a suitable buy order to match with the received continuous sell order, the method comprises the continuous order book matching the received continuous sell order with the suitable buy order. And when the continuous order book does not contain a suitable buy order to match with the received continuous sell order, the method comprises the continuous order book (i) storing the received continuous sell order in the continuous order book for matching with a suitable buy order in the future and (ii) considering the stored received continuous sell order when the continuous order book determines whether to decrease the current market price of the item to encourage buy orders.

Other embodiments include systems and methods of operating a continuous order book for binary options with a fixed-price and variable strike prices. An example of this type of binary option might be market participants (sometimes referred to as bettors in such embodiments) betting the point spread on a basketball game. The price of such a contract will be $0.50, but the conditions for which the buyer pays the seller changes. The system and methods comprise the continuous order book maintaining a current strike price for a binary option, wherein the continuous order book is configured to change (or otherwise update) the current strike price over time. As described above, the continuous order book in these binary option embodiments is also configured for matching buy orders with sell orders. In some embodiments, a buy order is or corresponds to a bet that the relevant condition of the event will be above the strike price, and a sell order is or corresponds to a bet that the relevant condition of the event will be below the strike price. After receiving a continuous buy order, the method comprises the continuous order book determining whether the continuous order book contains a suitable sell order to match with the received continuous buy order, wherein a continuous buy order is a bet that the relevant condition of the event will be above any strike price advertised by the order book. When the continuous order book contains a suitable sell order to match with the received continuous buy order, the method comprises the continuous order book matching the received continuous buy order with the suitable sell order. When the continuous order book does not contain a suitable sell order to match with the received continuous buy order, the method comprises the continuous order book (i) storing the received continuous buy order in the continuous order book for matching with a suitable sell order in the future and (ii) considering the received continuous buy order when the continuous order book determines whether to increase the current strike price to encourage sell orders.

After receiving a continuous sell order, some embodiments include the continuous order book determining whether the continuous order book contains a suitable buy order to match with the received continuous sell order, wherein a continuous sell order is or corresponds to a bet that the condition of the event will be below any strike price advertised by the continuous order book. When the continuous order book contains a suitable buy order to match with the received continuous sell order, the method comprises the continuous order book matching the received continuous sell order with the suitable buy order. When the continuous order book does not contain a suitable buy order to match with the received continuous sell order, the method comprises the continuous order book (i) storing the received continuous sell order in the continuous order book for matching with a suitable buy order in the future and (ii) considering the received continuous sell order when the continuous order book determines whether to decrease the current strike price to encourage buy orders.

### BRIEF DESCRIPTION OF THE DRAWINGS

FIG. 1 is a schematic diagram of a network that includes a continuous order book system configured for operating an order book according to some embodiments.

FIG. 2 is a flow diagram of a method for operating an order book by the continuous order book system according to some embodiments.

FIG. 3 is a flow diagram of a method for adjusting the current market price of an item by the continuous order book system according to some embodiments.

FIG. 4 is a flow diagram of a method for operating an order book by the continuous order book system according to some embodiments.

FIG. 5 is a flow diagram of a method for determining whether an order book includes matching orders within a limit according to some embodiments.

FIGS. 6A and 6B are flow diagrams of a method for operating an order book by the continuous order book system according to some embodiments.

FIG. 7 is a flow diagram of a method of operating an order book by the continuous order book system according to some embodiments.

FIG. 8 is a flow diagram of a method of operating an order book by the continuous order book system according to some embodiments.

FIG. 9 a method for adjusting the current market price of an item by the continuous order book system according to some embodiments.

FIG. 10 is a flow diagram of a method of operating an order book by the continuous order book system according to some embodiments.

FIGS. 11A and 11B are flow diagrams of a method for operating an order book by the continuous order book system according to some embodiments

FIG. 12 shows a method for operating a continuous order book according to some embodiments.

### DETAILED DESCRIPTION

Disclosed herein are methods and systems for implementing a continuous order book for items in a predictive market (e.g., derivative contracts based on an uncertain future event). The implementation of the methods and systems described herein provide a number of advantages over current order book systems. Because all orders are matched according to a singular current market price (or strike price in some embodiments) advertised by the continuous order book, and because the continuous order book adjusts the market price (or strike price) according to supply and demand, the continuous order book systems methods disclosed herein allow for individual market participants to both (i) have their orders filled without outstanding liquidity and (ii) experience significantly better execution on their orders. The improvements and capabilities realized by the disclosed continuous order book systems and methods do not require complicated trading systems like traditional order book systems. In addition, retail traders can quickly and easily execute transactions via the disclosed continuous order book systems and methods.

In addition to efficient execution, retail market participants should also benefit from price improvement when trading via the disclosed continuous order book systems because professional market participants are incentivized to make trades (e.g., with retail market participants) on smaller margins as the professional market participants are no longer taking the risk of their quotes getting picked off on the open market when they make an error, thus allowing the professional market participants to choose to trade when there is minimal risk. Traditional central limit order books, in contrast, require quoting systems that continually send and cancel orders in order to ensure professional market participants have efficient execution on their orders. Retail market participants experience worse execution quality as compared to professional market participants because the retail market participants do not have access to the complex systems operated by the professional market participants. Further, the retail market participants would not be able to operate the professional market participants' complex trading systems even if the retail market participants did have access to such systems.

Importantly, implementation of the continuous order book methods and systems disclosed herein provide technical improvements over traditional order book systems. For example, some embodiments of the continuous order book systems and methods disclosed and described herein require fewer computing and networking resources as compared to traditional systems operated using central limit order books. This is because the market prices and/or strike prices advertised by the continuous order book (i.e., transmitted to market participants from the continuous order book system) according to embodiments herein are based at least in part on how many bid and ask orders currently in the continuous order book rather than sophisticated pricing algorithms used by traditional systems operated using central limit order books.

Further technical improvements include reducing the number of Application Programming Interface (API) calls sent to the trading system, and thus, the number of API calls the system has to process. In order to replicate the improved execution quality granted by the continuous order book, market participants on a traditional central limit order book are required to send an order request, wait for a specified amount of time, cancel the order request, and then submit a new order request with a different limit price (this is a common technique employed by both retail and by institutional traders). This results in market participants sending many times more API calls to the exchange than would be required with embodiments of the central limit order book system disclosed herein. A trading system on a specific financial instrument usually has to process order requests serially. This means that most trading systems are unable to employ multiple threads to process order requests for a single trading system on a specific instrument, placing an upper bound on exchange throughput. As such, embodiments of the disclosed continuous order book systems and methods offers an improvement in the throughput of a trading system because users who would historically utilize a large amount of API calls to maximize execution quality would no longer need to do so.

The sophisticated pricing algorithms employed by traditional market makers rely on many different inputs from a variety of internal and external data sources to determine the bid and ask prices that a traditional order book system advertises to market participants. By contrast, the streamlined pricing methods employed by the disclosed embodiments allow the continuous order book to use fewer computing resources and rely on fewer data sources and use less network infrastructure to determine and advertise a current market price (or strike price) more efficiently and more rapidly as compared to traditional central limit order book systems that rely on complex price determination algorithms (e.g., based on inputs from many different sources) and complex price advertisement mechanisms (e.g., via repeated placing and canceling orders as described above). Some embodiments also result in lower research costs for professional traders because the traders only need to determine accurate prices in response to an outstanding order listed in the continuous order book that they are considering interacting with rather than using sophisticated price determination algorithms and complex price advertisement procedures to advertise prices at all times. Research costs include personnel and monitoring systems, including high-speed data feeds and other computing and networking infrastructure.

The continuous order book also enables markets on financial products and/or other items on which there previously may not have been any functioning markets. Institutional market makers whose participation is often required on central limit order books have high upfront costs to configuring their trading system. In low-volume environments, these institutional market makers will often not participate due to the upfront costs required. The continuous order book embodiments disclosed herein make provisioning liquidity much less technically sophisticated for the average market participant, thus allowing markets to function on financial products and/or other items previously ignored by institutional market makers.

The continuous order book also decreases the upkeep costs which market makers need to pay to continually participate in a market. With a central limit order book, market makers' quotes are constantly exposed to the market. As a result, they are vulnerable to making a mistake whenever the market is open and thus their trading systems need to be built to be accurate around the clock. This is an overly burdensome technical cost when demand for the underlying product is low. With the continuous order book, market makers need only produce accurate quotes when a participant creates an order and not around the clock as with traditional central limit order books.

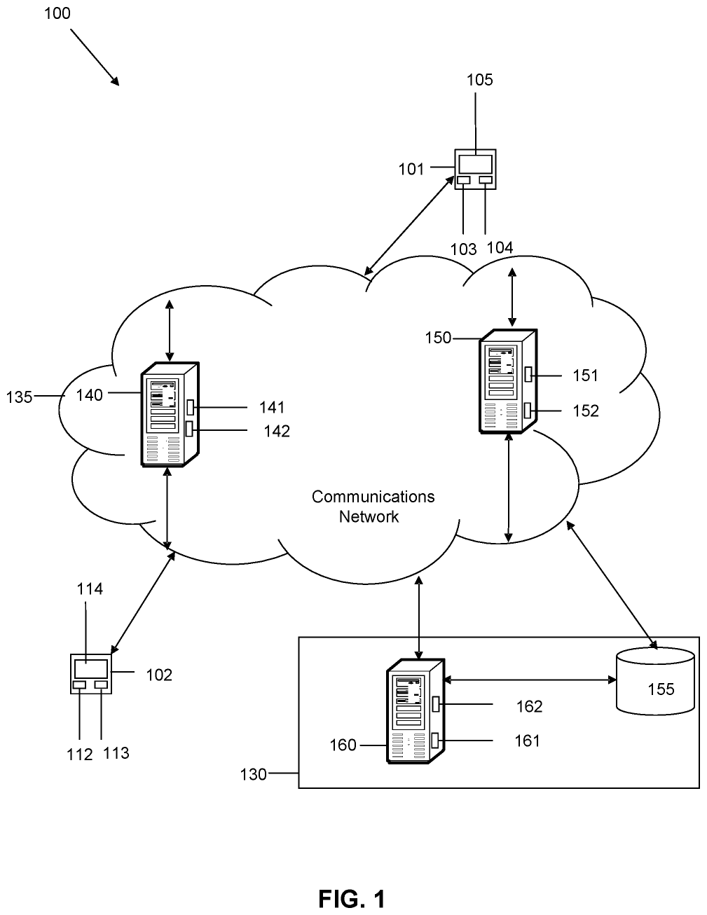

FIG. 1 is a schematic diagram of a system 100 that includes a communications network 135 to facilitate operation of a continuous order book system 130 according to some embodiments. The system 100 includes a plurality of user devices 101, 102, which are used by users to access the communication network 135. As an example, a user of a first user device 101 may transmit signals to access various online services and content, such as those available on an internet, on other devices, and/or on various computing systems. In certain embodiments, the first user device 101 includes a memory 103 that includes instructions, and a processor 104 that executes the instructions from the memory 103 to perform the various operations that are performed by the first user device 101. In certain embodiments, the processor 104 may be hardware, software, or a combination thereof. The first user device 101 may also include an interface 105 (e.g. screen, monitor, graphical user interface, etc.) that may enable the first user device 101 to interact with various applications executing on the first user device 101 and to interact with the system 100.

In certain embodiments, the user devices 101, 102 may be and/or may include a computer, any type of sensor, a laptop, a set-top-box, a tablet device, a phablet (phone-tablet), a server, a mobile device, a smartphone, a smart watch, and/or any other type of computing device. Illustratively, the user devices 101, 102 are each shown as a smartphone device in FIG. 1. In certain embodiments, the first user device 101 may be utilized by a user to access a continuous order book system 130 via the communication network 135.

The first user device 101 and/or additional user devices (e.g., user device 102) may belong to and/or form a communications network 135. In certain embodiments, the communications network 135 may be any type of local network, wide-area network, or other network or combination of networks that enables and/or facilitates various aspects of the functionality of the system 100. In certain embodiments, the communications network 135 may be formed between the first user device 101 and additional user devices through the use of any type of wired communications link(s), wireless communications link(s), or other protocol and/or technology. For example, user devices may communicate with one another in the communications network 135 by utilizing any protocol and/or wireless technology, satellite, fiber, or any combination thereof. Notably, the communications network 135 may be configured to communicatively link with and/or communicate with any other network of the system 100 and/or outside the system 100.

In addition to the first user device 101, the system 100 may also include a second user device 102. The second user device 102 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the second user 102 to interact with various applications executing on the second user device 102 and to interact with the system 100 and the continuous order book 130. In certain embodiments, the second user device 102 may be a computer, a laptop, a set-top-box, a tablet device, a phablet, a server, a mobile device, a smartphone, a smart watch, and/or any other type of computing device. Illustratively, the second user device 102 is shown as a smartphone in FIG. 1, but could be any other type of computing device.

In certain embodiments, the user devices 101, 102, and/or additional user devices may have any number of software applications and/or application services stored and/or accessible thereon. For example, the user devices 101, 102 include applications interacting with the continuous order book system 130, interactive social media applications, biometric applications, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications support the functionality provided by the system 100 and methods described in the present disclosure. In certain embodiments, the software applications and services include one or more graphical user interfaces so as to enable the users to readily interact with the software applications.

As mentioned above, the communications network 135 is configured to facilitate communications between and among the devices 101, 102 and the continuous order book 130. The communications network 135 may be under the control of a service provider, the first user device 101, the second user device 102, any other designated user, a computer, another network, or a combination thereof. The communications network 135 of the system 100 may be configured to link each of the devices in the system 100 to one another. Additionally, the communications network 135 may be configured to transmit, generate, and receive any information and data traversing the system 100. In certain embodiments, the communications network 135 may include any number of servers, databases, or other componentry. The communications network 135 may also include and be connected to a mesh network, a local network, a cloud-computing network, an IMS network, a VOID network, a security network, a VoLTE network, a wireless network, an Ethernet network, a satellite network, a broadband network, a cellular network, a private network, a cable network, the Internet, an internet protocol network, a content distribution network, any network, or any combination thereof. Illustratively, servers 140 and 150 are shown as being included within communications network 135. In certain embodiments, the communications network 135 may be part of a single autonomous system that is located in a particular geographic region, or be part of multiple autonomous systems that span several geographic regions.

In some embodiments, the servers 140, 150 reside in communications network 135, however, in certain embodiments, the servers 140, 150 reside outside communications network 135. In still other embodiments, the servers 140 and 150 also provide and serve as a server or cloud service that performs the various operations and functions provided by the system 100. The server 140 includes a memory 141 that includes instructions, and a processor 142 that executes the instructions from the memory 141 to perform various operations that are performed by the server 140. The processor 142 may be hardware, software, or a combination thereof. Furthermore, the server 150 includes a memory 151 that includes instructions, and a processor 152 that executes the instructions from the memory 151 to perform the various operations that are performed by the server 150. In certain embodiments, the servers 140, 150 are network servers, routers, gateways, switches, media distribution hubs, signal transfer points, service control points, service switching points, firewalls, routers, edge devices, nodes, computers, mobile devices, or any other suitable computing device, or any combination thereof. In certain other embodiments, the servers 140, 150 are communicatively linked to the communications network 135, any network, any device in the system 100, or any combination thereof.

The system 100 also includes the continuous order book system 130. The continuous order book system includes a server 160 and a database 155. The database 155 is utilized to store and relay information that traverses the system 100, cache content that traverses the system 100, store data about each of the devices 101, 102 and/or user accounts associated with the devices 101, 102 and perhaps other information about devices in the system 100 and/or perform any other typical functions of a database. In certain embodiments, the database 155 is connected to or resides within the communications network 135, any other network, or a combination thereof. In certain embodiments, the database 155 also serves as a central repository for any information associated with any of the devices and information associated with the system 100. Particularly, the database 155 is configured to store, among other data, (i) the current market price for each of a plurality of items, (ii) a plurality of order books for each of a plurality of items, (iii) information accessible by the server 160 to determine adjustments to the market price for one or more of the plurality of items for the order book(s), and (iv) account information for users of the continuous order book system 130. Furthermore, the database 155 may include a processor (not shown) and memory (not shown) or be connected to a processor and memory to perform the various operations associated with the database 155. In certain embodiments, the database 155 may be connected to the servers 140, 145, 150, 160, the user devices 101, 102, any devices in the system 100, any process of the system 100, any program of the system 100, any other device, any network, or any combination thereof. Furthermore, the database 155 may be configured to process queries sent to it by any device in the system 100, including but not limited to server 160 and/or user devices 101 and 102.

The server 160 included in the continuous order book system 130 includes a memory 161 that includes instructions, and a processor 162 that executes the instructions from the memory 161 to perform various operations that are performed by the server 160. The processor 162 may be hardware, software, or a combination thereof. In particular, the memory 161 includes tangible, non-transitory computer-readable media having stored therein instructions readable and executable by the processor 162 to perform the functions of the methods disclosed and described herein.

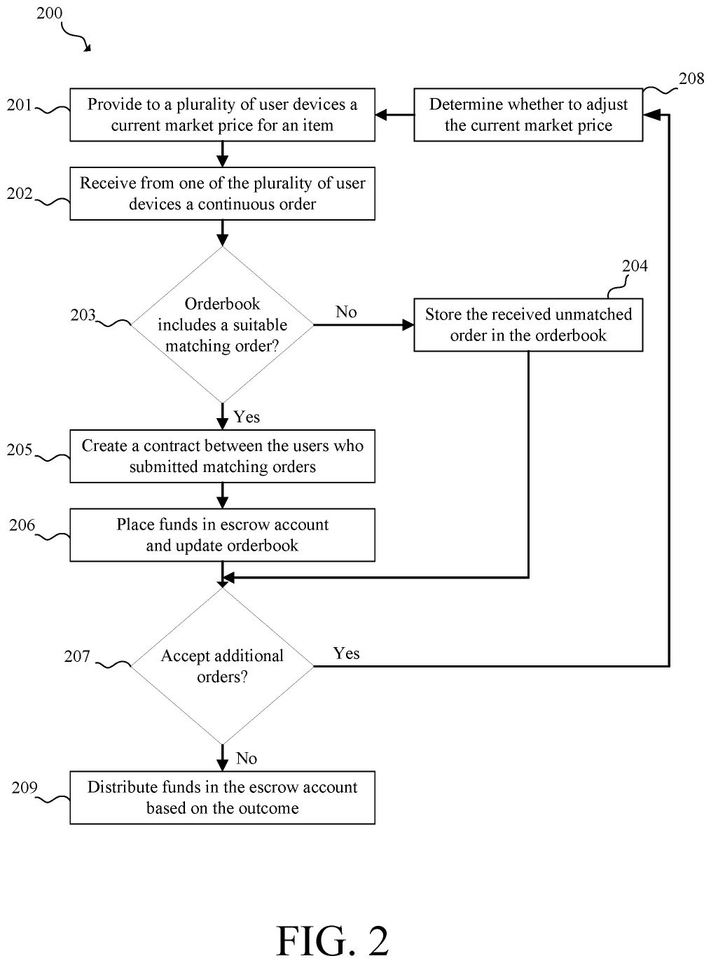

FIG. 2 shows a flow diagram of a method 200 for operating a continuous order book system, such as the continuous order book system 130 depicted in FIG. 1. At step 201, the method 200 includes the continuous order book system providing to a plurality of user devices a current market price for an item. In some embodiments, the item is an option, equity, debt, or futures contract, or any other tradable financial instrument now known or later developed. In other embodiments, the item is a bet on the outcome of a future event, such as a bet on the outcome of a sporting event or any other future event. When performing step 201, the continuous order book system provides to each user device connected to or accessing the continuous order book system the current market price for buying or selling the item.

At step 202, the method 200 includes the continuous order book system receiving from one of the plurality of user devices a continuous order. A continuous order is an order to buy or sell the item at any market price advertised or provided by the continuous order book system. Thus, the cost to buy or sell the item may be greater than, less than, or equal to the market price at the time a user places the continuous order. A user places the continuous order by interacting with a user device. As one example, the user places the continuous order by interacting with an application running on a user device, and the user device in turn transmits the order to the continuous order book. Alternatively, the user places the continuous order by accessing via a personal computer a web user interface provided by a server connected to the continuous order book system.

At step 203, the method 200 includes the continuous order book system determining whether an order book includes a suitable matching order. That is, if at step 202 the continuous order book system receives a continuous buy order for an item, then at step 203 the continuous order book system determines whether the continuous order book already has suitable sell orders for the item. Thus, if the continuous order book system receives a buy order for 50 shares, the continuous order book system would check whether there are suitable sell orders on the book for at least 50 shares. The continuous order book system might match with suitable buy orders based on age priority. In this case, the sell orders would be filled one at a time starting with the oldest until 50 shares are matched against the new buy order.

Similarly, if at step 202 the continuous order book system receives a continuous sell order for an item, then at step 203, the continuous order book system determines whether there is a suitable buy orders for the item.

Thus, if the continuous order book system receives a sell order for 50 shares, the continuous order book system would check whether there are suitable buy orders on the book for at least 50 shares. The continuous order book system might match with suitable buy orders based on age priority. In this case, the buy orders would be filled one at a time starting with the oldest until 50 shares are matched against the new sell order.

If the continuous order book system determines that there is not a suitable matching order for the received order, the method 200 continues at step 204, where the continuous order book system adds the received order to the order book. The continuous order book system includes a database, such as the database 155 discussed with respect to FIG. 1, which includes an order book for each item traded on the continuous order system. In some embodiments, the continuous order book system matches outstanding orders logged in the order book with new incoming orders in the sequence in which the outstanding orders were received, preferably according to a first in, first out methodology.

In some examples, the continuous order book system may be configured to match orders even though the received order is not fully filled by outstanding orders in the order book. For example, if the order book only has a single sell order for 20 shares, the continuous order book system makes a partial match of a 50-share buy order. In this case, the continuous order book system would update the order book to indicate a 30-share buy order, which would be matched with successive sell orders until all 30 shares of the buy order were matched. Alternatively, if the order book has only a single buy order for 20 shares, the continuous order book system makes a partial match of a 50-share sell order. In this case, the continuous order book system would update the order book to indicate a 30-share sell order, which would be matched with successive buy orders until the remaining shares of the sell order are matched.

If the continuous order book system determines that there is a suitable matching order at step 204, the method 200 continues to step 205, where the continuous order book system creates a contract between the users who submitted the matching orders identified at step 204.

In some financial instrument trading embodiments, the contract is a standard options, futures, or commodities contract. For example, if the item is a call option, the purchase price is the price that the buyer pays to the seller for the right to purchase the asset related to the option contract from the seller before a future date specified in the contract. In some betting embodiments, to create the contract, the continuous order book system sets the purchase price of the contract and a payout amount, at least one of which is based on the current market price for the item at the time the continuous order book system matches the buy and sell orders. In one example, the purchase price represents the amount of money the buyer is obligated to pay the seller if the future event does not occur. Conversely, the payout amount represents the amount of money the seller is obligated to pay the buyer if the future event occurs.

In some examples, the current market price is the cost of a share for the item and is established at a value greater than $0 and less than $1.00. The following formulae represent the purchase price and payout amount per share of the item:

purchaseprice=cmp*n

payout amount=($1.00−cmp)*n

where the cmp is the current market price and n is the number of shares sold. However, the purchase price and payout amount could be calculated according to other formulae instead.

At step 206, the continuous order book system places funds covering the purchase price and the payout amount in an escrow account. In some examples, each user maintains an account with the continuous order book system in which funds are stored. The continuous order book system withdraws the purchase price and payout amount from the buyer's and seller's accounts, respectively, and places the withdrawn funds in an escrow account. Additionally or alternatively, the continuous order book system withdraws the requisite funds from the buyer's and/or seller's financial institution, or account at a derivatives clearing organization, perhaps by processing a credit card or electronically withdrawing the funds from a bank account. Also at step 206, the method 200 includes the continuous order book system removing the preexisting order from the order book. In some embodiments, a participant's funds are put into escrow when they place an order instead of when their order is filled. The amounts put in escrow could be equal to the total amount a participant could lose from their position.

After completing steps 204 or 206, the method 200 includes determining whether to stop accepting orders for the item at step 207. For instance, if the item is whether an event has occurred, the continuous order book system stops accepting new orders at a cut-off time before the conclusion of the event. In some examples the cut-off time is when the event begins. In other examples, the cut-off time is some fixed period of time before the end of the event. If the event is a football game, for instance, the cut-off time corresponds to a time remaining in the game, such as perhaps two minutes remaining in the fourth quarter. However, the cut-off time could be any time prior to the completion of the event.

If at step 207 the continuous order book system determines to continue accepting orders, the method 200 continues at step 208, where the continuous order book system determines whether to adjust the current market price.

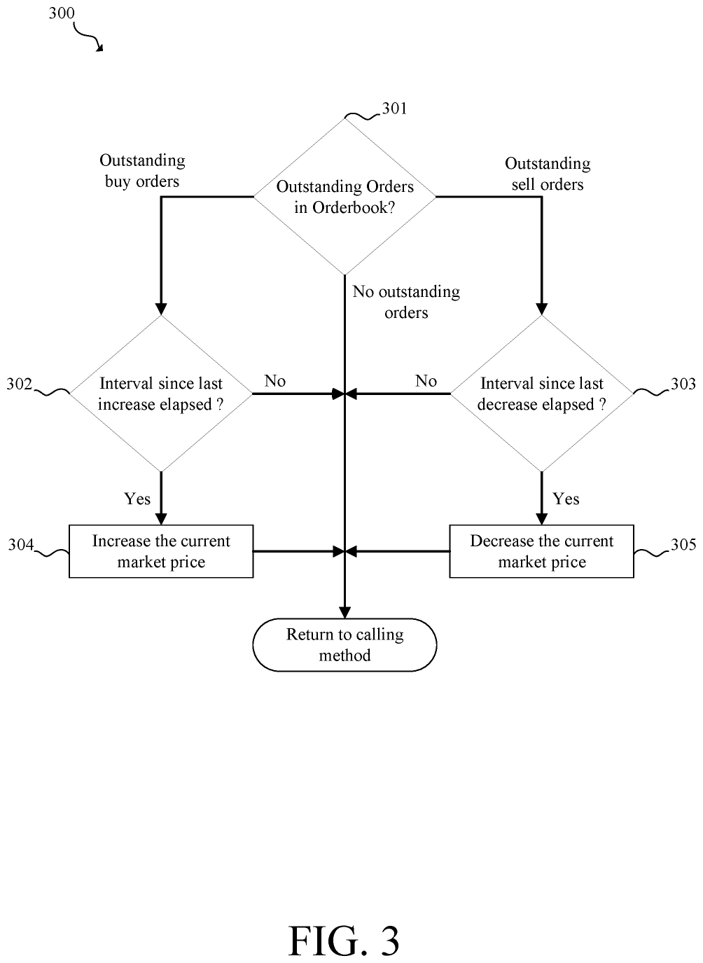

FIG. 3 is a flow diagram of a method 300 for adjusting the current market price of the item. The continuous order book system is configured to adjust the current market price of the item to encourage users to submit matching orders for the outstanding orders in the order book. Thus, at step 301 the method 300 includes the continuous order book system determining if there are outstanding orders for an item. If the continuous order book system determines that there are outstanding buy orders, the method 300 proceeds to step 302. If the continuous order book system determines that there are outstanding sell orders, then the method 300 proceeds to step 303.

At step 302, the method 300 includes determining whether a time interval has elapsed since the last time the continuous order system increased the current market price.

The interval between increases to the current market price can take a number of forms. In one example, the continuous order book system is configured to increase the current market price once a second (or some other time interval). In another example, the continuous order book system is configured to increase the current market price a plurality of times per second, thereby allowing for a time interval between increases that is less than once per second, and could be on the order of milliseconds. And in other examples, the continuous order book system applies increases to the current market price at a slower temporal rate, such as once every few seconds or minutes. In some embodiments, the time interval between updates could be variable, increasing or decreasing over time or changing as a function of some other properties, such as the percentage of remaining time left or the difference between current market price and $0.50.

In some examples, the interval between increases to the current market price depends on factors such as the number of shares subject to outstanding (unmatched) buy orders, the total value of the outstanding buy orders, or/and the rate at which orders for the item are made. For instance, as the number of shares subject to outstanding buy orders increases, the interval between increases to the current market price gets shorter. In another example, as the volume of matched orders being placed on an item increases, the interval between adjustments to the current market price gets longer. This latter case accounts for the likelihood that both buyers and sellers believe that the item is properly priced. That is, a large volume of both buy and sell orders indicates that an increase or decrease in the current market price is not needed to attract sell orders or buy orders.

If the continuous order book system determines that sufficient time has elapsed since the last increase to the current market price, the method 300 continues at step 304. Otherwise, the method 300 concludes without increasing the current market price. Also note that, in one example, the continuous order book system is configured to increase the current market price whenever there is a surplus of buy orders. In this example, the continuous order book system does not perform step 304 and proceeds directly to step 306.

At step 304, the continuous order book system increases the current market price to a new current market price. Having outstanding buy orders for an item indicates that the current market price is too low for users to place a sell order. In order to encourage users to place sell orders, the continuous order book system increases the current market price. The continuous order book system can implement a variety of techniques to determine how much the current market price increases. As one example, the continuous order book system calculates a new current market price by adding the current market price to a positive constant. Alternatively, the continuous order book system employs a scaling function to more quickly achieve a fair market price for the item. As one example, the continuous order book system uses the following formula to increase the price:

cmp_{new}=(0.5−|cmp−0.5|)* [symbol] cmp

where cmp is the current market price, cmp_{new} is the new market price, and c is a constant greater than zero. As compared to multiplying the current market price by a constant, applying a scaling formula such as the one described above allows for more rapid increases in the current market price when the current market price is at an extreme (i.e., close to $0 per share) and smaller changes as the current market price exceeds the midpoint (i.e., $0.50 per share).

Additionally, as with the interval between increases, the constant used to calculate the new current market price can be replaced with a variable that can depend on variable factors, such as the number of shares subject to outstanding (unmatched) buy orders, the total value of the outstanding buy orders, or/and the rate at which orders for the item are made. In one example, the variable increases as the total number of shares subject to buy orders increases. Alternatively, as the volume of matched orders for the item increases, the continuous order book system replaces the constant with a variable that reduces the increase in the current market price, thereby keeping the market price relatively constant.

After the continuous order book system increases the current market price, the method 300 concludes, and the continuous order book system returns to the method 200.

At step 303, when there is a surplus of outstanding sell orders, the method 300 includes determining whether to decrease the current market price.

Similar to step 302, the continuous order book system, in order to determine whether to decrease the current market price, first determines whether an interval has elapsed since the last decrease to the current market price. The allowable time between decreases to the current market price can take a number of forms. In one example, the continuous order book system is configured to decrease the current market price once a second (or some other time interval). In another example, the continuous order book system is configured to decrease the current market price multiple times per second, thereby allowing for a time interval between decreases that is less than once per second, and could be on the order of milliseconds. And in yet other examples, the continuous order book system decreases the current market price at a slower temporal rate, such as once every few seconds.

In some examples, the interval between decreases to the current market price depends on factors such as the number of shares subject to outstanding (unmatched) sell orders, the total value of the outstanding sell orders, or/and the rate at which orders for the item are made. For instance, as the number of shares subject to outstanding sell orders increases, the interval between decreases to the current market price gets shorter. In another example, as the volume of matched orders being placed on an item increases, the interval between decreases to the current market price gets longer. As discussed with respect to step 304, this latter case accounts for the likelihood that both buyers and sellers believe that the item is properly priced.

If the continuous order book system determines that sufficient time has elapsed since the last decrease to the current market price, the method 300 continues at step 305. Otherwise, the method 300 concludes without increasing the current market price. Also note that, in one example, the continuous order book system is configured to decrease the current market price whenever there is a surplus of sell orders. In this example, the continuous order book system does not perform step 303 and proceeds directly to step 305.

At step 305, the continuous order book system decreases the current market price to a new current market price. A surplus of sell orders for an item indicates that the current market price is too high for users to place a buy order. In order to encourage users to place buy orders to fill the outstanding sell orders, the continuous order book system decreases the current market price. The continuous order book system can implement a variety of techniques to decrease the current market price. As one example, the continuous order book system calculates a new current market price by adding the current market price to a negative constant. Alternatively, the continuous order book system employs a scaling function to normalize the rate of variation over the range of possible prices. As one example, the continuous order book system uses the following formula to decrease the current market price:

cmp_{new}=(0.5−|cmp−0.5|) [symbol] *+cmp

where cmp is the current market price, cmp_{new} is the new current market price, and c is a constant less than zero. This is the same formula as the one discussed with respect to an illustrative example in step 306, with the difference being that the constant is less than one. As compared to multiplying the current market price by a constant, applying a scaling formula such as the one described above allows for more rapid increases in the current market price when the current market price is low (i.e., close to $0 per share) and smaller changes as the current market price exceeds the midpoint (i.e., $0.50 per share).

Additionally, as with the interval between increases, the constant used to calculate the new current market price can be replaced with a variable that can also depend on variable factors, such as the number of shares subject to outstanding (unmatched) sell orders, the total value of the outstanding sell orders, or/and the rate at which orders for the item are made. In one example, the value of the constant can be replaced with a variable which decreases as the total number of shares subject to buy order increases. Alternatively, as the volume of orders for the item increases, the continuous order book system replaces the constant with a variable that reduces the rate at which the current market price decreases after each interval thereby keeping the current market price relatively constant.

After the continuous order book system decreases the current market price, the method 300 concludes, and the continuous order book system returns to the method 200.

After completing the adjustment of the current market price at step 208, the method 200 returns to step 201 and provides the current market price to the user devices. The method may continue receiving and matching orders by performing steps 201-208 until the cut-off time is reached. At that point, the method 200 concludes at step 209, where the continuous order book system, at the conclusion of the event, transfers the funds in the escrow account to the buyers if the event occurs and to the sellers if the event does not occur.

To further illustrate the implementation of the method 200, consider an example in which the item is a bet on the result of a basketball game between the Celtics and the Warriors. At step 201, the continuous order book system provides to the plurality of user devices a current market price to buy the Warriors (e.g., a bet that the Warriors will win) at $0.51. In one example, the continuous order book system also provides the current market price to buy the Celtics (e.g., a bet that the Celtics will win) at $0.49. Providing both market prices allows users to make bets based on their personal preferences. That is, a given user may be more inclined to sell the Celtics (e.g., bet that the Celtics will lose) than to buy the Warriors, even though they are effectively the same bet. Thus, providing the plurality of user devices with both current market prices provides the users with additional flexibility to customize the user interface.

At step 202, the continuous order book system receives from Alice (via her user device) a continuous order to buy 100 shares of the Warriors. At step 203, the continuous order book system checks the order book for orders to sell the Warriors. In this example, the order book includes an order from Anna to sell 100 shares of the Warriors. The continuous order book system determines that there is a match for Alice's order and creates a contract between Alice and Anna at step 205. In this example, the purchase price is $51 (100 shares×$0.51/share) and the payout amount is $49 (100 shares×($1.00−$0.51)/share). At step 206, the continuous order book system deducts $51 from Alice's account and $49 from Anna's account and places $100 in the escrow account. Also at step 206, the continuous order book system updates the order book to remove Anna's sell order from the order book. The continuous order book system continues to accept new orders until the cut-off time is reached. Once the game is over, at step 209 the continuous order book system will deposit $100 in Alice's account if the Warriors win, or the continuous order book system will deposit $100 in Anna's account if the Warriors lose.

As a further illustrative example, suppose that the continuous order book system determines at step 203 that the order book does not include any sell orders. In this case, at step 204 the continuous order book system adds to the order book Alice's order to buy 100 shares of the Warriors. Then after determining at step 207 that the continuous order system can accept additional orders, at step 208 the continuous order book system determines whether to adjust the current market price for the Warriors. The continuous order book system proceeds to the method 300, where at step 301 the continuous order book system determines that there is a surplus of buy orders, namely Alice's order. After determining at step 302 that the interval since the last increase in the current market price for the Warriors has elapsed, at step 304 the continuous order book system increases the current market price for the Warriors to $0.52. The continuous order book system then provides the new market price to the plurality of user devices at step 201 of the method 200.

Now returning to step 202, the continuous order book system receives an order from Brian to sell 100 shares of the Warriors. At step 203, the continuous order book system matches Brian's sell order to Alice's buy order and creates a contract at step 205. However, as a result of the increase in the current market price, the purchase price is now $52 (100 shares×$0.52/share) and the payout amount is $48 (100 shares×($1.00−$0.52)/share). As in the prior example, the continuous order book system deducts the purchase price and the payout amount from Alice's and Brian's accounts, respectively, and places $100 in the escrow account. The continuous order book system continues to accept new orders until the cut-off time is reached. Then at step 209, the continuous order book system deposits $100 in either Alice's or Brian's account, depending on the outcome of the game.

In a further technical embodiment, the continuous order book might be configured such that the global market price follows a consistent discrete pattern such as every $0.01 between $0.01 and $0.99 ($0.01, $0.02 . . . $0.99). In this case, the continuous order book might keep a running total of “points.” Based on an interval (such as every second), the continuous order book would check a variety of factors including the current market price, the number of outstanding orders, the size of outstanding orders, and the sequencing of recent activity in order to determine how many points to add or subtract from the system. If the total number of points after an update exceeds a specified threshold, the continuous order book will increment the price up. If instead the number of points is below a specific lower threshold, then the continuous order book will increment the price down. One example of this system involves adding 1 point per second for each contract outstanding to buy and subtracting 1 point per second for each contract outstanding to sell. The price might increment or decrement based on every 1000 points. This means that if there were outstanding orders to buy 100 contracts, the price would increment every 10 seconds.

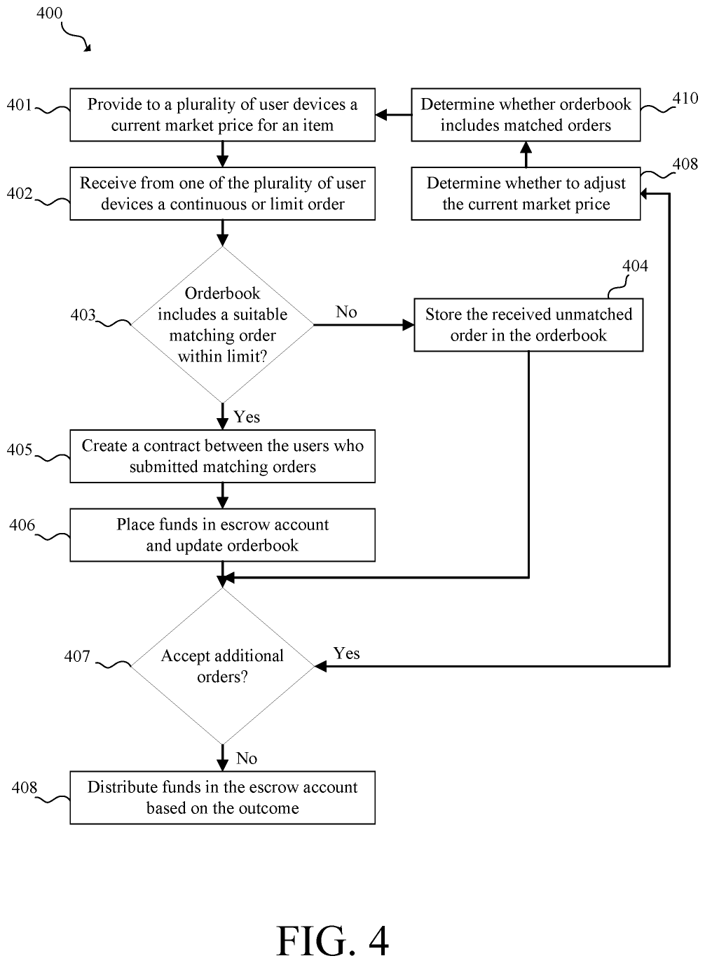

In another example, the continuous order book system is configured to implement a hybrid continuous order book. FIG. 4 is a flow diagram of a method 400 for operating a hybrid continuous order book. Steps 401 and 404-409 of the method 400 are substantially similar to steps 201 and 204-209, respectively, and are therefore not discussed in detail again. However, at step 402 of the method 400 includes the continuous order book system receiving from one of the plurality of a user devices a continuous order or a limit order. A limit buy order indicates the maximum price at which a user will buy an item, while a limit sell order indicates the minimum price at which a user will sell an item.

At step 403, the method 400 includes determining whether the order book includes a suitable matching order for an item. In practice, the continuous order book system will treat a limit sell order as a continuous sell order when the current market price is at or above the sell limit, but the continuous order book system will not match the sell limit order when the current market price is below the sell limit. Similarly, the continuous order book system will treat a limit buy order as a continuous buy order when the current market price is at or less than the current market limit, but the continuous order book system will not match an order if the current market price exceeds the buy limit. In some embodiments the exchange will give users the option to automatically cancel their limit order if it becomes non-viable (either the price exceeds the buy limit or is below the sell limit) or after a specified amount of time has elapsed.

To further illustrate the operation of the hybrid continuous book, consider an example in which an order book includes a continuous order from Jim to buy 100 shares of the Warriors. When the current market price is $0.52, Alice places an order to sell 100 shares of the Warriors at a limit sell price of $0.53. Although Alice has offered to sell enough shares of the Warriors to match Jim's buy order, the continuous order book system does not consider Alice's offer because the current market price ($0.52) is less than her sell limit ($0.53). Thus, the continuous order book system does not match Jim's and Alice's orders, and the continuous order book system adds Alice's order to the order book at step 404.

At step 408, after determining to accept additional orders at step 407, the continuous order book system determines whether to adjust the current market price by performing the steps of the method 300. Because the current market price is less than the sell limit for Alice's order, the continuous order book system in some embodiments may not consider Alice's order when determining whether there are outstanding orders at step 301 (but in other embodiments, the continuous order book system may consider unmatched limit orders when determining whether to adjust the market price). Accordingly, the continuous order book system determines that there is a surplus of orders to buy the Warriors and, after determining that the interval since the last increase has elapsed at step 303, the continuous order book system increases the current market price to buy the Warriors to $0.53.

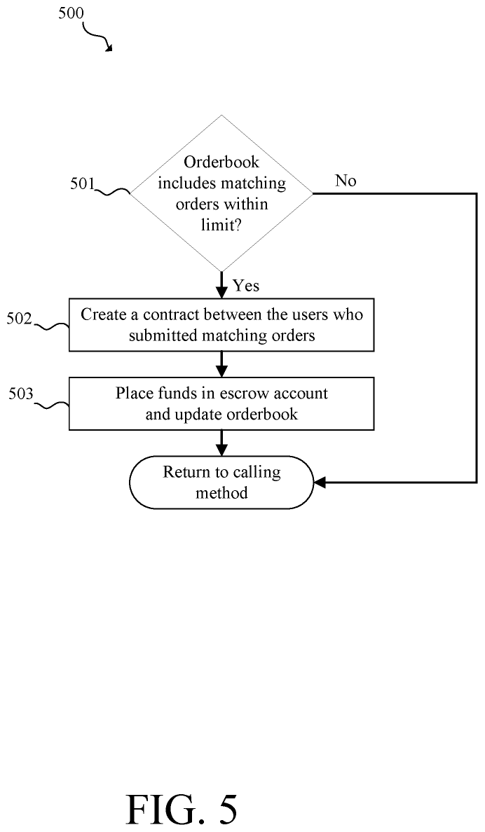

Returning to the method 400, at step 410, the method 400 includes determining whether the order book includes matched orders. FIG. 5 shows an example method for determining whether the order book includes matched orders after an adjustment to the market price. If a change in the market price results in a limit being met, performing the method 500 causes the continuous order book system to match outstanding buy and sell orders before receiving any new orders.

At step 501, the method 500 includes the continuous order book system determining whether the order book includes matching orders. If there are matching orders, then the method 500 continues with steps 502 and 503, which are substantially the same as steps 405 and 406, respectively (and steps 205 and 206, respectively). The one notable difference is that both buy and sell orders are removed from the order book at step 503.

Thus, continuing the prior illustrative example, because the new market price is equal to Alice's sell limit, the continuous order book system treats Alice's sell order as a continuous order. At step 501, the continuous order book system therefore matches Alice's sell order to Jim's buy order. The continuous order book system proceeds to create a contract between Alice and Jim (step 502), places the purchase price and the payout amount in the escrow account (step 503), and removes both Alice's and Jim's orders from the order book. The continuous order book system then returns to performing the steps of the method 400 until the game is over and escrowed funds are distributed.

In the previous examples and methods, a received order matched to a preexisting order is immediately executed by the continuous order book system. However, in some situations, a person with an order on the books is at a disadvantage. This is particularly true when a user has early access to information that is not available to other users. As one example, a user watching a game on television sees what is happening a few seconds after a person watching live at the venue as a result of broadcast delays. Thus, a person watching an event in-person has a potential advantage over a user watching at home.

To illustrate this potential further, consider an example where Bob is at a stadium watching a football game between the Buccaneers and Dolphins, while Alice is watching at home. The order book includes an order from Alice to buy 100 shares of the Buccaneers. During the game, the Buccaneers quarterback suffers a serious injury. Bob, who sees the injury happen, immediately sells 100 share of the Buccaneers. The continuous order book system, executing the methods 200 and 400, would immediately pair Bob's received sell order to Alice's existing buy order, thereby allowing Bob to benefit from his early access to the information about the injury at Alice's expense.

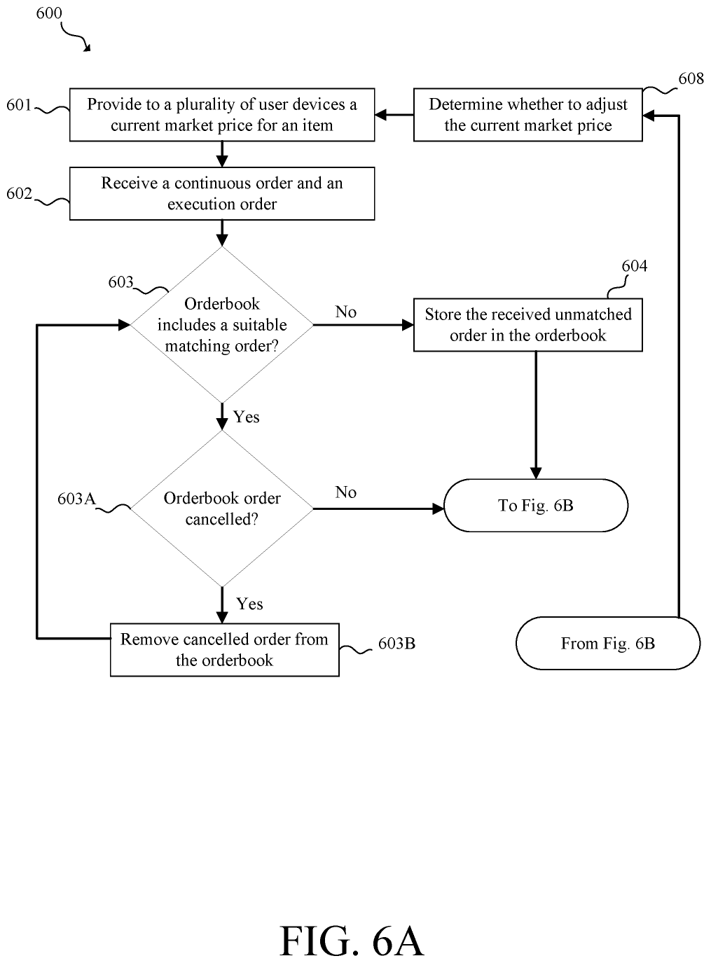

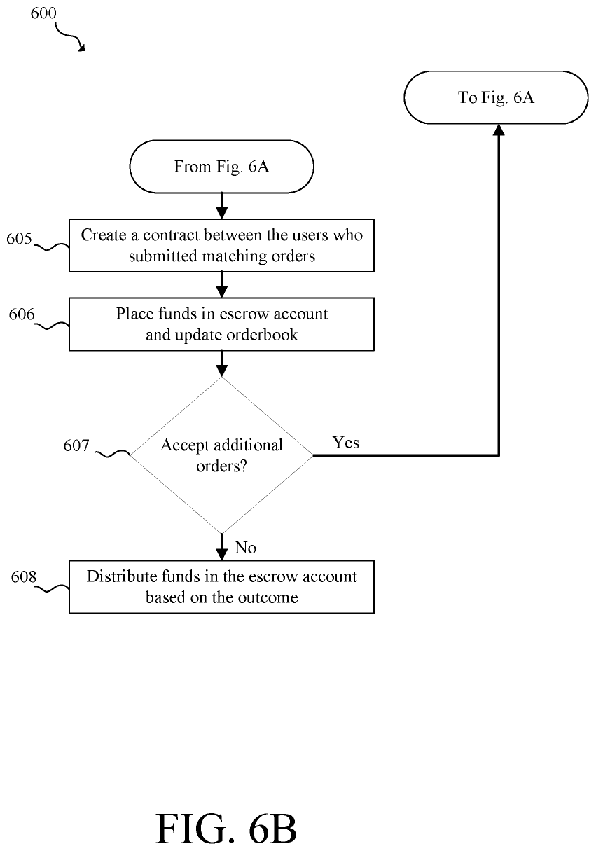

In one example, the continuous order book system provides an option for delaying execution of a booked order. FIGS. 6A-B show a flow diagram of a method 600 for operating a continuous order book. Steps 601 and 603-609 are substantially similar to steps 401 and 403-409 and are therefore not discussed in detail. At step 602, the method 600 includes the continuous order book system receiving from one of the plurality of user devices a continuous order or an execution order. The order may be a buy or sell order, as discussed with respect to prior examples. The execution order indicates whether the user wants to immediately enter into a contract upon the continuous order book system matching the order, with the user's order having been placed in the order book. The user can elect to form a contract as soon as the order is matched, or the user can elect to have delayed execution of the order after the order is placed in the order book. At step 603, the method 600 includes the continuous order book system determining if there is a matching order to the received order, as described with respect to FIGS. 2 and 4. If the continuous order book system does not identify a match, the continuous order book system proceeds to step 604, which is substantially the same as steps 204 and 404 of the methods 200 and 400, respectively.

If the continuous order book system matches the received order to a preexisting order, then at step 603A the method 600 includes determining whether the order book order has been cancelled. On the one hand, if the user selected the delayed execution option when placing an order and submitted a cancellation request within a delay time, perhaps via a user device connected to the continuous order book system, the method 600 continues at step 603B, where the continuous order book system removes the cancelled order from the order book. After removing the order, the continuous order book system returns to step 603 and attempts to match the received order to another preexisting order in the order book. On the other hand, if the user did not select the delayed execution option or failed to cancel the order before the expiration of the delay time, the continuous order book system proceeds to step 605, where the contract is made in a manner discussed with respect to steps 205 and 405 of the methods 200 and 400, respectively. The delay time is preferably at least three to five seconds and possibly several more seconds, though any suitable delay time may be used.

Referring again to the illustrative example, suppose Alice's order to buy 100 shares of the Buccaneers included a delay option (or was otherwise not immediately executable). Upon seeing the Buccaneers quarterback being injured on television, Alice cancels her buy order. If she cancels the order within the delay time, then her order is not matched to Bob's sell order, and the continuous order book system removes Alice's buy order from the order book at step 603B. The continuous order book system then returns to step 603 to determine if the order book has a suitable match to Bob's sell order.

Although the continuous order book system is configured to provide an accurate market price for an item relative to the supply and demand, there may be situations where there is a significant disparity between the current market price and the actual or perceived value of the item. For instance, in a sporting event, an injury to a star player—such as the Buccaneers quarterback in the previous illustrative example—could have a sudden and significant impact on the value of the Buccaneers (and, by extension, the Dolphins). Depending on how quickly the continuous order book system is configured to adjust the current market price for an item, there could be a significant period of inactivity, as it will take some amount of time for the continuous order book system to adjust the market price to reach a new fair market value.

To address this situation, the continuous order book system may receive via the communication network an indication of a third-party price for an item. Although the continuous order book system does not rely on the price set by a third party, the continuous order book system may, in some embodiments, nonetheless monitor one or more third parties' prices for items traded via the continuous order book system. In the event a disparity is detected between the current market price for the item in the continuous order book and a third parties' price (or perhaps a disparity of more than a threshold amount), the continuous order book system may reset the market price for the item in order to more closely align the current market price with other prices being offered by others in the market.

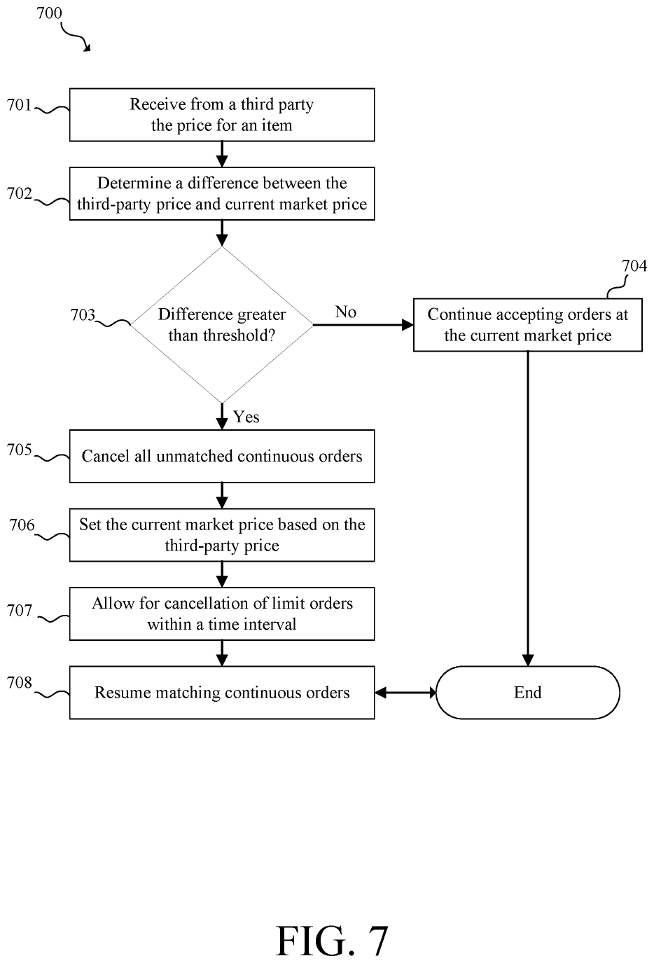

FIG. 7 is flow diagram of a method 700 for resetting the market price of an item. At step 701, the method 700 includes the continuous order book system receiving from a third party a price for an item. By way of example, the price may be indicative of the odds set by a sportsbook on the outcome of a sporting event.

At step 702, the method 700 includes determining a difference between the third-party price and the current market price for the item. In some embodiments, the continuous order book system calculates the difference as a percent difference.

At step 703, the method 700 includes the continuous order book system determining if the difference is greater than a threshold. In one example, the threshold is plus or minus 20%, though the threshold could be greater than or less than 20% depending on a given item and other factors, such as the volume of trading on an item or the amount of time remaining before the cut-off time, to name two non-exclusive examples.

If the continuous order book system determines that the difference between the third-party price and the current market price is less than the threshold, the method 700 continues at step 704 with the continuous order book system continuing to accept orders at the current market price.

On the other hand, if the difference is greater than the threshold, the continuous order book system initiates the process for resetting the market price for the item. At step 705, the method 700 includes the continuous order book system cancelling all unmatched continuous orders. Thus, the continuous order book system removes from the order book the outstanding continuous sell orders and/or the outstanding continuous buy orders. At step 706, the method 700 includes the continuous order book system setting a new market price for the item based at least in part on the third-party price. In one example, the continuous order book system sets the current mark price of the item to match or otherwise be equivalent to the third-party's price. At step 707, the method 700 includes the continuous order book system allowing users to cancel their existing limit orders within a specified time interval. The length of the interval can be as short as several seconds or as long as necessary under the circumstances. Again, factors such as the amount of time remaining to the cut-off time and the volume of trading prior to cancelling the continuous orders may affect the length of the time interval of step 707. In some embodiments, the closer in time to the cut-off time, and the greater the volume of trading prior to the reset, the shorter the time interval allowed for canceling limit orders. In further embodiments, users may elect to have their limit orders automatically cancelled in the event the order book market price is reset, as described above.

In one example, the continuous order book system also accepts new orders during the cancellation time interval. Although the continuous order book system may not match new orders during the cancellation time interval, the continuous order book system may use the new orders to update the current market price. As the time interval for cancelling limit orders approaches zero, the continuous order book system in one example locks in the new market price prior to the expiration of the cancellation time interval. Then, at step 708, the continuous order book system resumes matching offers based on the new market price, and the method 700 ends.

In some of the examples discussed thus far, each item being traded has had a binary outcome: one team wins and one team loses. However, the continuous order book system can be configured to accept orders on items that have more than two possible outcomes. This broadens the potential scope of items to include games where there could be a tie, as well as events where there are more than two contenders. Examples of this latter category include golf tournaments, horse racing, and political contests.

For an item that has more than two potential outcomes, the continuous order book system recognizes a buy order on one outcome as a sell order on every other outcome. The continuous order book system would therefore instantly match the buy order with a sell order on the outcome or buy orders on every other outcome. If the continuous order book system does not match the buy order for a given outcome, the continuous order book system raises the current market price for that given outcome and lowers the current market price for every other outcome similar to the methods for increasing the market price described above.

Similarly, the continuous order book system would recognize a sell order on one outcome as a buy order on every other outcome. The continuous order book system would thus instantly match the sell order with a buy order on the same outcome or sell orders on every other outcome. If the continuous order book system cannot match the sell order for a given outcome, the continuous order book system decreases the price for the given outcome and raises the price for every other outcome similar to the methods for decreasing the market price described above.

In the preceding examples, the orders were presented as purchases of shares by or selling an item. However, in some examples the continuous order book system is configured to receive orders according to the cash value of the trade. In this manner, the orders more closely resemble bets, which may be appealing to certain users. In these examples, the continuous order system determines at steps 205, 405, and 605 of the method 200, 400, and 600, respectively, the contract as having the purchase price of the buy order, and the payout price is given by the following equation:

$$PO = PP ( \frac{\$ 1}{c m p} - 1 )$$

Where PO is the payout price, PP is the purchase price (i.e., buy order), and cmp is the current market price for the item at the time the contract is made.

In a further example of the present invention, the item can be a binary option with a fixed price of $0.50 and a movable strike price based on a measurable value of an event, rather than a binary option with a variable price and fixed strike price. For example, the item could be a point spread bet on the number of points scored by a team at the end of the game. The point spread indicates the predicted margin of victory for the favored team. In this case, a buy order would be a bet that the value would be above the strike price at the end of the game.

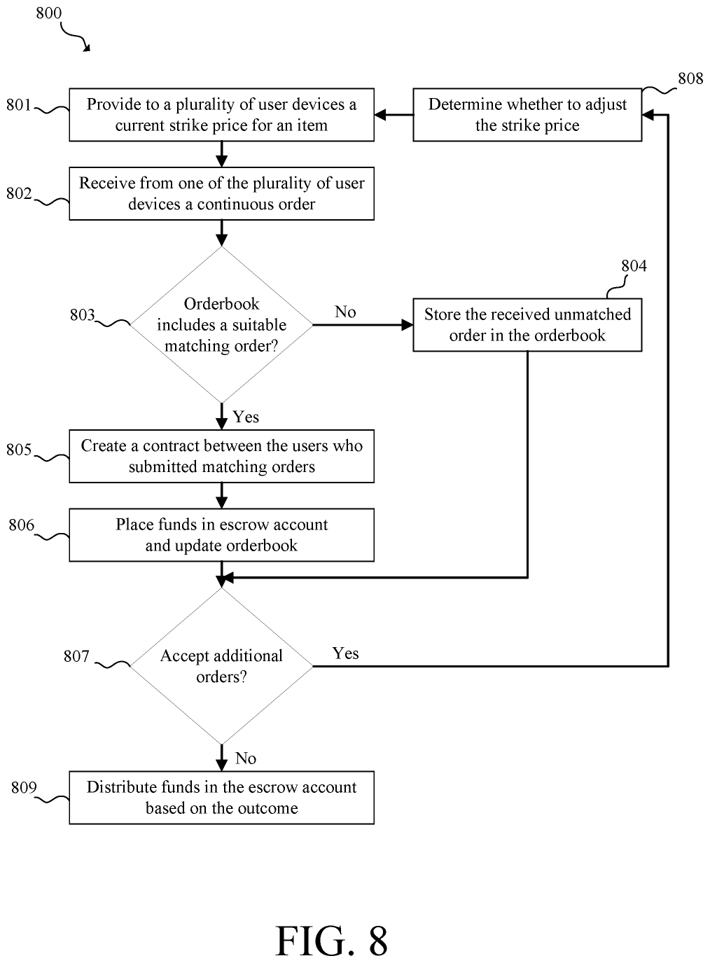

FIG. 8 shows a flow diagram of a method 800 for operating a continuous order book system according to still further embodiments. At step 801, the method 800 includes the continuous order book system providing to a plurality of user devices a current strike price for a binary option. When performing step 801, the continuous order book system provides to each of the user devices connected to or accessing the continuous order book system the strike price of the binary option, or at least provides the strike price for the binary option to the user devices that have requested to receive the price. For example, if the item is a college football game between Michigan and Ohio State, the point spread of Michigan +7 indicates that Michigan is favored to win the game by more than seven points.

At step 802, the method 800 includes the continuous order book system receiving from one of the plurality of user devices a continuous order. A user places the continuous order by interacting with a user device. As one example, the user places the continuous order by interacting with an application running on a user device. Alternatively, the user places the continuous order by accessing via a personal computer a web user interface provided by a server connected to the continuous order book system. Here a buy order corresponds to a bet that the favored team will cover—that is, win by more than the spread—and a sell order corresponds to a bet that the favored team will not cover—the favorite either will lose or will win by less than or equal to the point spread. A user can place the order as cash, shares, or any other similarly exchangeable asset accepted by the continuous order book system.

At step 803, the method 800 includes the continuous order book system determining whether the order book includes a suitable matching order. Here, the continuous order book system performs substantially the same steps as discussed with respect to step 203 of the method 200. If the continuous order book system determines that there is not a suitable matching order for the received order, the method 800 continues at step 804, where the continuous order book system adds the received order to the order book. Here, the continuous order book system performs the same steps as discussed with respect to step 204 of the method 200.

If the continuous order book system determines that there is a suitable matching order at step 803 the method 800 continues to step 805, where the continuous order book system creates a contract between the users who submitted the matching orders identified at step 804. Unlike the situation where the continuous order system maintains a current market price for the item, the determination of the purchase price and payout amount is straightforward: in fixed binary options with variable strike prices, the payout is one-to-one. Thus, the purchase price is the same as the sale price. However, in step 805 the continuous order book system sets the strike price as the current strike price at the time the orders were matched.

At step 806, the method 800 includes the continuous order book system placing the funds covering the purchase price and the payout amount in an escrow account, as described with respect to step 206 of the method 200. That is, the funds from the buy order and the sell order are placed in the escrow account. Thus, by way of example, if the buy order is $100 for Michigan to cover, the corresponding sell order is $100, and $200 is placed in the escrow account. As in step 206, the continuous order book system withdraws the purchase price and payout amount from the buyer's and seller's accounts, respectively, and places the withdrawn funds in an escrow account. Additionally or alternatively, the continuous order book system withdraws the requisite funds from the buyer's and/or seller's financial institutions, perhaps by processing a credit card or electronically withdrawing the funds from a bank account. Also at step 806, the method 800 includes the continuous order book system removing the preexisting order from the order book.

After completing step 806, or after adding the received order (or a portion thereof) to the order book at step 804, the method 800 includes determining whether to stop accepting orders for the item at step 807. In performing step 807, the continuous order book system performs substantially the same steps as discussed with respect to step 207 of the method 200.

If at step 807 the continuous order book system determines to continue accepting orders, the method 800 continues at step 808, where the continuous order book system determines whether to adjust the current strike price.

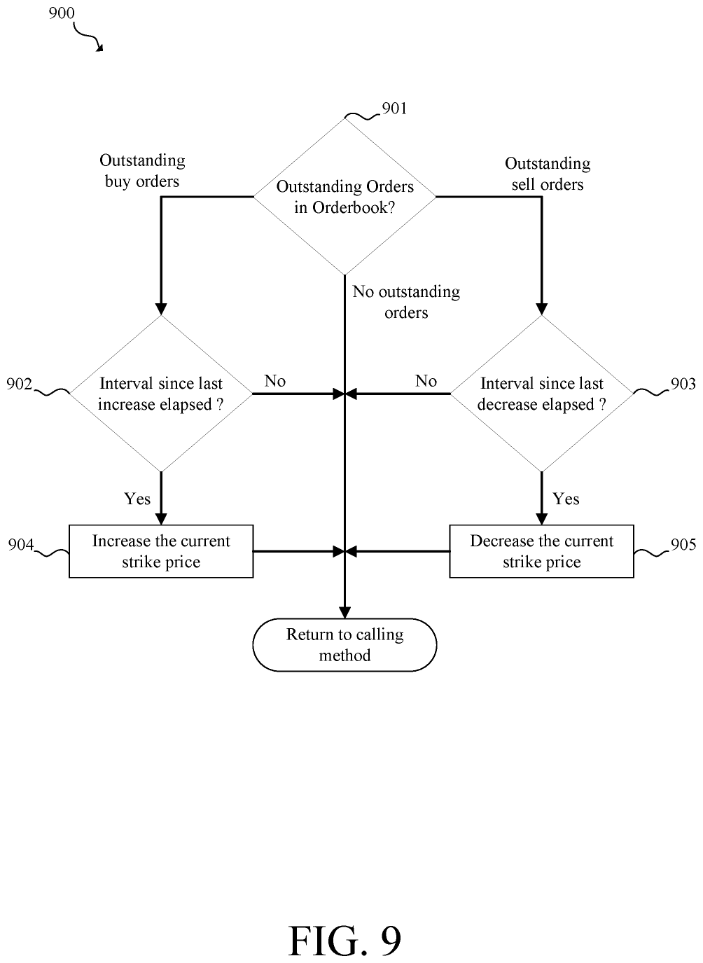

FIG. 9 is a flow diagram of a method 900 for adjusting the current strike price of the item. The continuous order book system is configured to adjust the current point spread of the item to encourage matching orders for the outstanding orders in the order book. Thus, at step 901, the method 900 includes the continuous order book system determining if there are outstanding orders. If the continuous order book system determines that there are outstanding buy orders, the method 900 proceeds to step 902. If the continuous order book system determines that there is a surplus of sell orders, then the method 900 proceeds to step 903.

At step 902, the method 900 includes the continuous order book system determining whether an amount of time has elapsed since the last update. The time between increases to the current strike price can take a number of forms. In one example, the continuous order book system is configured to increase the current strike price once per second (or perhaps some other fixed time interval). In another example, the continuous order book system is configured to increase the point spread multiple times per second, thereby allowing for a time interval between increases that is less than once per second, and could be on the order of milliseconds. And in other examples, the continuous order book system increases to the current market price at a slower temporal rate, such as once every few seconds.

In some examples, the interval between increases to the current point spread depends on factors such as the number of shares subject to outstanding (unmatched) buy orders, the total value of the outstanding buy orders, or/and the rate at which orders for the item are made. For instance, as the number of shares subject to outstanding buy orders increases, the interval between increases to the current point spread decreases. In another example, as the volume of matched orders being placed on an item increases, the interval between adjustments to the current point spread also increases. This latter case accounts for the likelihood that both buyers and sellers believe the strike price is close to being balanced. That is, a large volume of both buy and sell orders indicates that an increase in the strike price is not needed to attract sell orders and/or that a decrease in the strike price is not needed to attract buy orders.

If the continuous order book system determines that sufficient time has elapsed since the last increase to the current point spread, the method 900 continues at step 904. Otherwise, the method 900 concludes without increasing the strike price. Also note that, in one example, the continuous order book system is configured to increase the strike price whenever there is a surplus of buy orders. In this example, the continuous order book system does not perform step 902 and proceeds directly to step 904.

At step 904, the method 900 includes the continuous order book system increasing the strike price to a new strike price. A surplus of buy orders for an item indicates that the current strike priced is too narrow for users to place a sell order. The continuous order system thus increases the strike priced to encourage more sell orders. When performing step 904, the continuous order system performs the same steps, and considers one or more of the same factors, as discussed with respect to step 304.

After the continuous order book system increases the strike price, the method 900 concludes, and the continuous order book system returns to the method 800.

At step 903, similar to step 902, the continuous order book system determines whether an interval has elapsed since the last decrease to the strike price. In performing step 903, the continuous order book system performs substantially the same functions, and considers one or more of the same factors, in determining whether the time interval since the last decrease of the strike price has elapsed, as described with respect to step 303 of the method 300.

If the continuous order book system determines that sufficient time has elapsed since the last decrease to the current strike price, the method 900 continues at step 905. Otherwise, the method 900 concludes without decreasing the strike price. Also note that, in one example, the continuous order book system is configured to decrease the current strike price whenever there is a surplus of sell orders. In this example, the continuous order book system does not perform step 903 and proceeds directly to step 905.

At step 905, the continuous order book system decreases the current strike price to a new strike price. A surplus of sell orders for an item indicates that the current strike is too high for users to place a buy order. In order to encourage users to place buy orders, the continuous order book system decreases the strike price. When performing step 905, the continuous order system performs the same steps, and considers one or more of the same factors, as discussed with respect to step 305.

After the continuous order book system decreases the strike price, the method 900 concludes, and the continuous order book system returns to the method 800.

After completing the adjustment of the current at step 808, the method 800 returns to step 801 and provides the current strike price to the user devices. The method may continue receiving and matching orders by performing steps 801-808 until the cut-off time is reached. At that point, the method 800 concludes at step 808, where the continuous order book system, at the conclusion of the event, transfers the funds in the escrow account to the buyers if the measured event occurs in such a way that the measurement of interest is above the strike price (as set by each contract), or to the sellers if the measured event occurs in such a way that the measurement of interest is below the strike price.

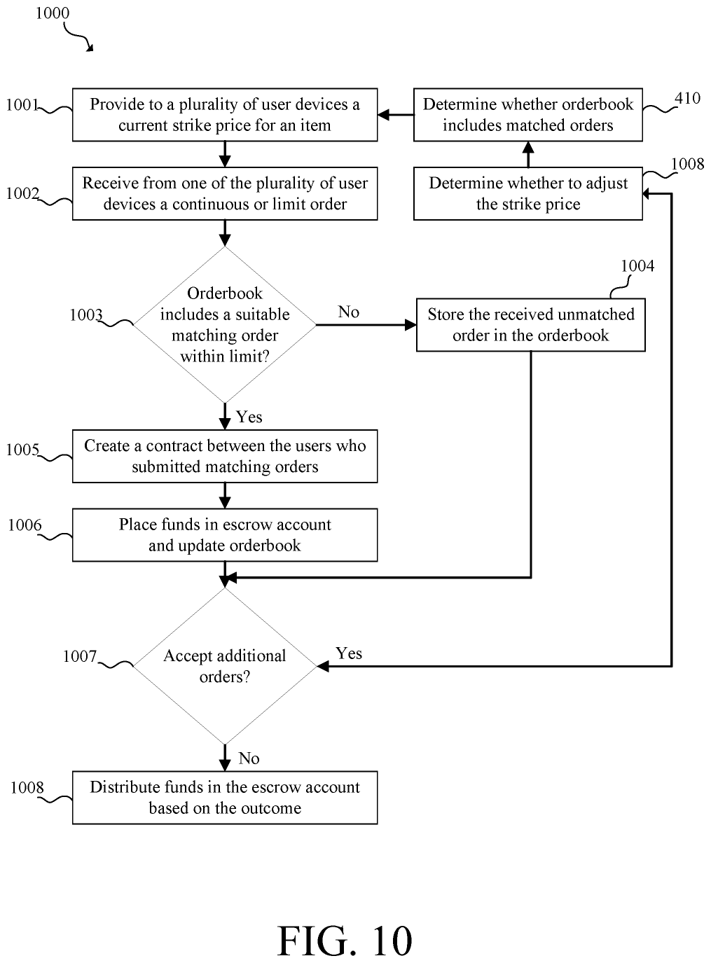

In another example, the continuous order book system is configured to implement a hybrid continuous order book for a point spread. FIG. 10 is a flow diagram of a method 1000 for operating such a hybrid continuous order book. Steps 1001 and 1004-1009 of the method 1000 are substantially similar to steps 801 and 804-809, respectively, and thus are not described in detail again. However, in step 1002, the method 1000 includes the continuous order book system receiving from one of the plurality of user devices a continuous order or a limit order. Here, a limit buy order is the maximum strike price at which a user will buy the outcome, and a limit sell order is the minimum strike price at which a user will sell the outcome.

At step 1003, the method 1000 includes determining whether the order book includes a suitable matching order for an item. At step 1003 of the method 1000, the continuous order book system will treat a limit sell order as a continuous sell order when the current strike price is at or above the sell limit, but the continuous order book system will not match the limit sell order when the current strike price is below the sell limit. Similarly, the continuous order book system will treat a limit buy order as a continuous buy order when the current strike price is at or less than the current market limit, but the continuous order book system will not match an order if the current strike price exceeds the buy limit.

At step 1008, the continuous order book system determines whether to adjust the current strike price by performing the steps of the method 1000. The continuous order book system, when determining whether to adjust the strike price, will perform the steps of the method 900, except that in some embodiments, the continuous order book system may not consider a limit sell order when the strike price is below the order's sell limit, and the continuous order system may likewise not consider a limit buy order when the strike price is above the order's buy limit. In other embodiments, the continuous order book system may consider unmatched limit sell orders and limit buy orders when considering whether to adjust the current strike price.

At step 1010, the method 1000 includes determining whether the order book includes matched orders. The continuous order book system may perform the same or substantially the same steps as discussed with respect to the method 500 when performing the steps of the method 1000.

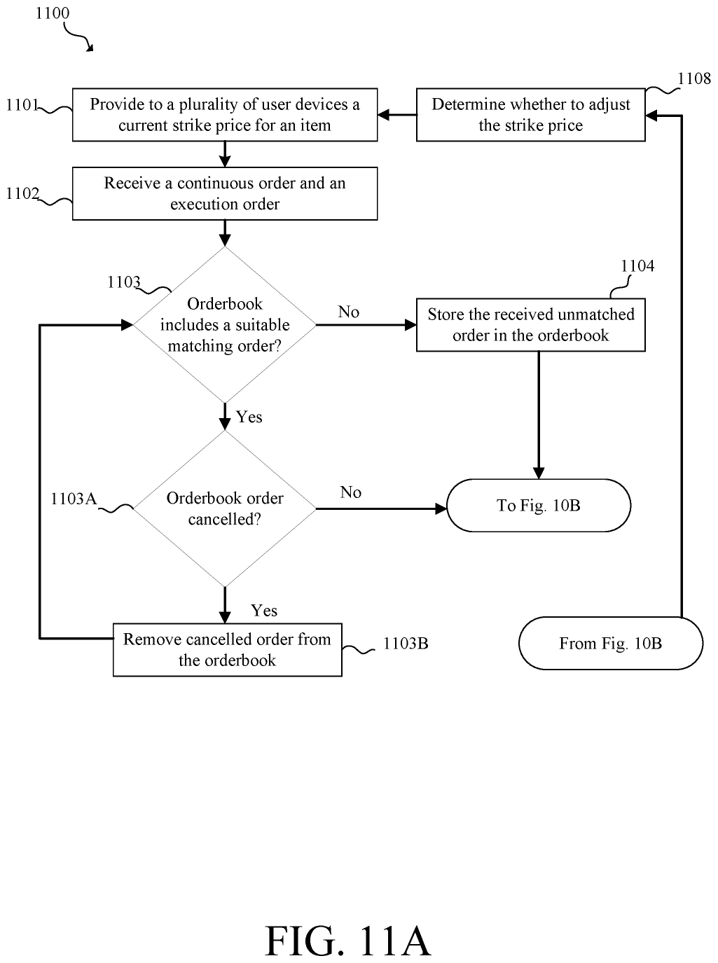

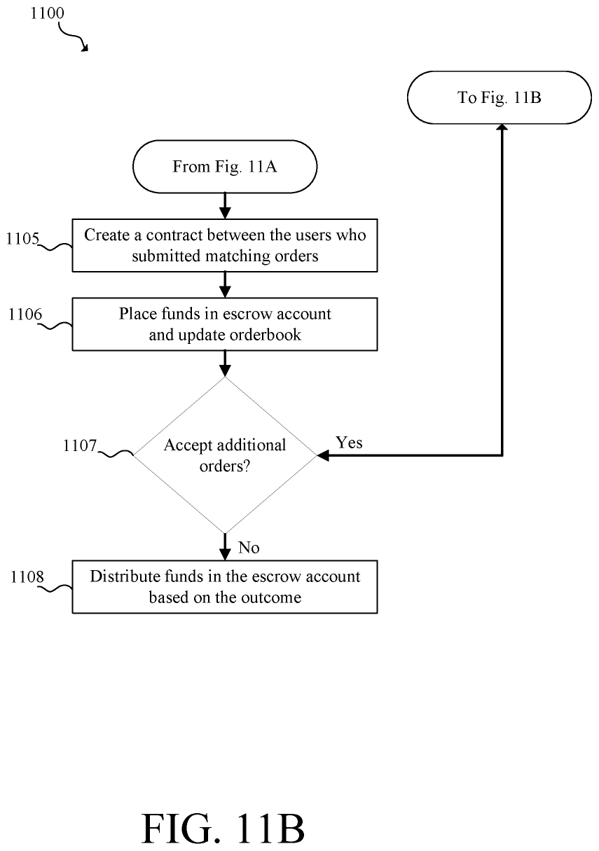

Similar to the reasons discussed with respect to the method 600, the continuous order book system in some embodiments provides an option for delaying execution of a booked order at a strike price for an item. FIGS. 11A-B show a flow diagram of a method 1100 for operating a continuous order book according to some embodiments. Steps 1101 and 1103-1109 are substantially similar to steps 801 and 803-809 and are therefore not discussed in detail. At step 1102, the method 1100 includes the continuous order book system receiving from one of the plurality of user devices a continuous order or an execution order. The order may be a buy or sell order, as discussed with respect to prior examples. The execution order indicates whether the user wants to immediately enter into a contract upon the continuous order book system matching the order, with the user's order having been placed in the order book. The user can elect to form a contract as soon as the order is matched, or the user can elect to have delayed execution of the order after the order is placed in the order book. At step 1103, the method 1100 includes the continuous order book system determining if there is a matching order to the received order, as described with respect to FIGS. 8 and 10. If the continuous order book system does not identify a match, the method proceeds to step 1104, which is substantially the same as steps 204 and 404 of the methods 200 and 400, respectively.

If the received order is matched to a preexisting order, then at step 1103A the method 1100 includes determining whether the order has been cancelled. If the user selected the delayed execution option when placing the order, and if the user submitted a cancellation request within a delay time, perhaps via the user device, then the method 1100 continues at step 1103B, where the continuous order book system removes the cancelled order from the order book. After removing the cancelled order, the continuous order book system returns to step 1103 and attempts to match the received order to another preexisting order in the order book. On the other hand, if the user did not select the delayed execution option or failed to cancel the order before the expiration of the delay time, then the continuous order book system proceeds to step 1105, where the contract is made. The delay time is preferably at least three to five seconds and possibly several more seconds, though any suitable delay time may be used.

Referring back to FIG. 7, it should be noted that, although the method 700 is described in an example where the continuous order system receives orders based at least in part on a market price, the method can be implemented for situations where the item is a binary option with a fixed price and variable strike price as described with reference to FIGS. 8, 9, 10, and 11. That is, the continuous order system may also periodically receive a third party's binary option price for an event. If the difference between the current point spread and the third party's strike price exceeds a threshold, then the continuous order book system performs the steps 705-708 of the method 700 in order to reset the point spread. In some embodiments, the continuous order book system does not match order book orders on a first-in, first-out basis. In this case, if the continuous order book system could not match a plurality of buy orders to a corresponding plurality of suitable sell orders, the orders may be combined, and the continuous order book system would allocate the matched contracts for the buys order to each buyer each on a pro rata basis. In one example, the continuous order book system determines the percentage of matched orders by dividing the value of each buyer's orders over the total value of all outstanding buy orders. For example, if Alice placed an unmatched order to buy 100 shares of an item and the value of the outstanding buy orders was equivalent to 1,000 shares, Alice would be responsible for contributing 10% of the purchase price and would receive 10% of the payout for a favorable outcome. In other embodiments the contracts are allocated using a blend of pro rata and time priority matching where users who submitted their orders first are entitled to a larger proportion of the matched contracts. Further, although the preceding example involved buy orders, the same or similar pro rata distribution can be made for sell orders.

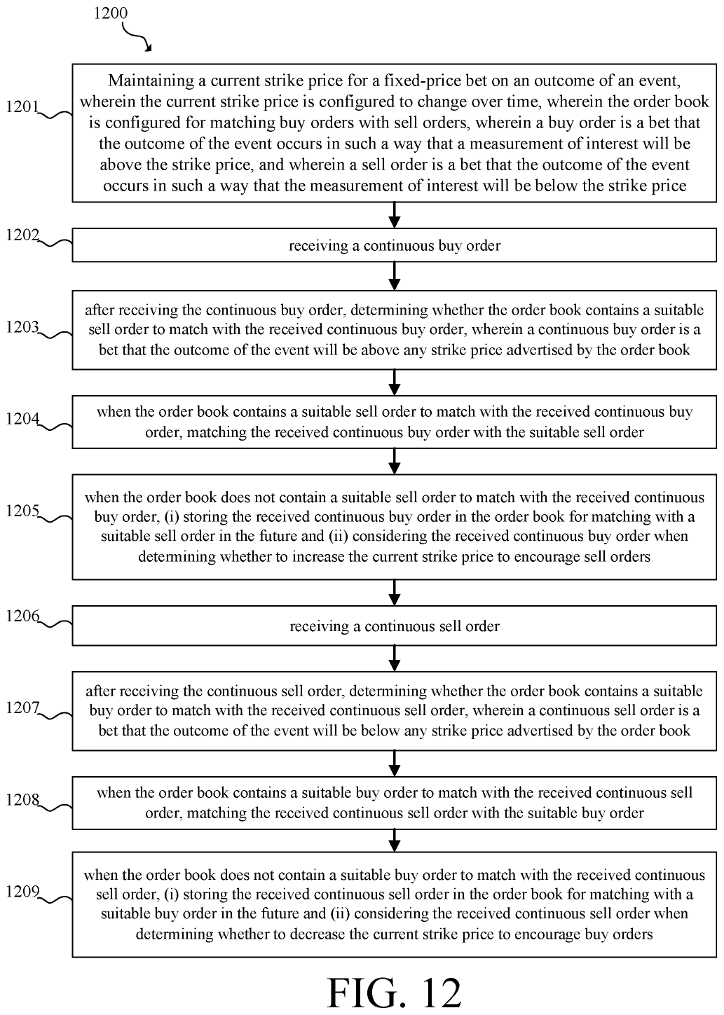

FIG. 12 shows a method 1200 of operating a continuous order book according to some embodiments. The steps of method 1200 may be performed in any order. Some embodiments may include performing fewer than all of the method steps 1201-1209 shown in FIG. 12. Likewise, some embodiments may include performing further method steps in addition to steps 1201-1209. Aspects of method steps 1201-1209 may be the same as or similar to other method steps relating to determining market prices and matching buy and sell orders disclosed and described herein.

In practice, the continuous order book operated according to method 1200 is configured for matching buy orders with sell orders. In the context of method 1200, a buy order is a bet that the outcome of an event occurs in such a way that a measurement of interest will be above the strike price. And a sell order is a bet that the outcome of the event occurs in such a way that the measurement of interest will be below the strike price. In some embodiments, the outcome of the event may correspond to the score or other outcome of a sporting event. In other embodiments, the outcome of the event may correspond to the price of a security, commodity, or other item at some future time, such as whether the price of the security or commodity is above or below a certain price at some future time. In further embodiments, the outcome of the event may correspond to the result of economic data such as GDP or the unemployment rate.

Method 1200 begins at block 1201, which includes the continuous order book maintaining a current strike price for a fixed-price bet on the outcome of an event. In operation, the continuous order book is configured to change/update the current strike price over time based on several factors described further herein. In some embodiments of method 1200, the continuous order book is configured to change the current strike price over time in a manner similar to how other embodiments disclosed herein describe a continuous order book changing (or updating) current market prices for items.

Next, method 1200 advances to block 1202, which includes the continuous order book receiving a continuous buy order from a market participant. In some embodiments, an individual continuous buy order received from a market participant includes an indication of whether the continuous order book should (i) match the continuous buy order with a suitable sell order via the order book as soon as possible or (ii) match the continuous buy order with a suitable sell order via the order book after a delay period, wherein the continuous buy order may be cancelled during the delay period.

Method 1200 next advances to block 1203, which includes, after receiving the continuous buy order, the continuous order book determining whether it contains a suitable sell order to match with the received continuous buy order. A continuous buy order is a bet that the outcome of the event will be above any strike price advertised by the continuous order book. In some embodiments, determining whether the order book contains a suitable sell order to match with the received continuous buy order comprises determining whether the continuous order book contains at least one of (i) a continuous sell order to match with the received continuous buy order or (ii) a limit sell order having a corresponding strike price that is below the current strike price, wherein a limit sell order is a bet that the outcome of the event will be below the corresponding strike price for the limit sell order, and wherein the limit sell order is treated as a continuous sell order as long as the current strike price is greater than the corresponding strike price for the limit sell order.

Next, method 1200 advances to block 1204, which includes, when the continuous order book contains a suitable sell order to match with the received continuous buy order, the continuous order book matching the received continuous buy order with the suitable sell order.

In some embodiments, each buy order received from a buyer that is matched with a corresponding sell order received from a seller creates a contract between the buyer and the seller. The contract has both (i) a strike price based on the current strike price at the time the buy order is matched with the sell order and (ii) a payout price. In operation, the contract (i) obligates the buyer to pay the payout price to the seller when the outcome is below the strike price for the contract and (ii) obligates the seller to pay the payout price to the buyer when the outcome is above the strike price for the contract.

In some embodiments, matching a received continuous buy order with the suitable sell order at block 1204 includes, when a total quantity of continuous buy orders received from a plurality of buyers exceeds a total quantity of suitable sell orders for matching with the continuous buy orders, allocating the total quantity of suitable sell orders to the plurality of buyers pro rata to each buyer according to a quantity of continuous buy orders received from the buyer divided by the total quantity of continuous buy orders received from the plurality of buyers.

Some embodiments additionally or alternatively include receiving a limit buy order having a corresponding strike price. In such embodiments, matching the limit buy order with a suitable sell order includes (i) when the current strike price is less than the corresponding strike price for the limit buy order, matching the limit buy order with a continuous sell order in the continuous order book as long as the current strike price is less than the corresponding strike price of the limit buy order, and (ii) when the current strike price is greater than the corresponding strike price for the limit buy order, storing the limit buy order in the order book for matching with a suitable sell order in the future.

Next, method 1200 advances to block 1205, which includes, when the continuous order book does not contain a suitable sell order to match with the received continuous buy order, (i) storing the received continuous buy order in the continuous order book for matching with a suitable sell order in the future and (ii) considering the received continuous buy order when the continuous order book determines whether to increase the current strike price to encourage sell orders.

Next, method 1200 advances to block 1206, which includes the continuous order book receiving a continuous sell order from a market participant. In some embodiments, an individual continuous sell order includes an indication of whether the continuous order book should (i) match the continuous sell order with a suitable buy order via the continuous order book as soon as possible or (ii) match the continuous sell order with a suitable buy order via the continuous order book after a delay period, wherein the continuous sell order may be cancelled during the delay period.

Next, method 1200 advances to block 1207, which includes, after receiving the continuous sell order, determining whether the continuous order book contains a suitable buy order to match with the received continuous sell order. A continuous sell order is a bet that the outcome of the event will be below any strike price advertised by the continuous order book.

In some embodiments, determining whether the continuous order book contains a suitable buy order to match with the received continuous sell order at block 1207 comprises determining whether the continuous order book contains at least one of (i) a continuous buy order to match with the received continuous sell order or (ii) a limit buy order having a corresponding strike price that is above the current strike price, wherein a limit buy order is a bet that the outcome of the event will be above the corresponding strike price for the limit buy order, and wherein the limit buy order is treated as a continuous buy order as long as the current strike price is less than the corresponding strike price for the limit buy order.

Some embodiments additionally or alternatively include the continuous order book receiving a limit sell order having a corresponding strike price. In such embodiments, matching the limit sell order with a suitable buy order includes (i) when the current strike price is greater than the corresponding strike price for the limit sell order, matching the limit sell order with a continuous buy order in the continuous order book as long as the current strike price is greater than the corresponding strike price of the limit sell order, and (ii) when the current strike price is less than the corresponding strike price for the limit sell order, storing the limit sell order in the continuous order book for matching with a suitable buy order in the future.

Next, method 1200 advances to block 1208, which includes when the continuous order book contains a suitable buy order to match with the received continuous sell order, matching the received continuous sell order with the suitable buy order.

In some embodiments, matching the received continuous sell order with the suitable buy order at block 1208 includes, when a total quantity of continuous sell orders received from a plurality of sellers exceeds a total quantity of suitable buy orders for matching with the continuous sell orders, allocating the total quantity of suitable buy orders to the plurality of sellers pro rata to each seller according to a quantity of continuous sell orders received from the seller divided by the total quantity of continuous sell orders received from the plurality of sellers.

Next, method 1200 advances to block 1209, which includes, when the continuous order book does not contain a suitable buy order to match with the received continuous sell order, (i) storing the received continuous sell order in the order book for matching with a suitable buy order in the future and (ii) considering the received continuous sell order when the continuous order book determines whether to decrease the current strike price to encourage buy orders.

Some embodiments of method 1200 additionally include both (i) the continuous order book increasing the current strike price for the bet to encourage more sellers under certain circumstances, such as when there are more buy orders than sell orders in the continuous order book and (ii) the continuous order book decreasing the current strike price for the bet to encourage more buyers under certain circumstances, such as when there are more sell orders than buy orders in the continuous order book. Some such embodiments additionally include the continuous order book (i) after increasing the strike price for the bet, determining whether the continuous order book contains a suitable sell order to match with any previously-stored buy order, and/or (ii) after decreasing the current strike price for the bet, determining whether the continuous order book contains a suitable buy order to match with any previously-stored sell order.

Some embodiments of method 1200 additionally include both (i) the continuous order book determining whether to increase the current strike price (or market price) to encourage sell orders based at least in part on how many unmatched buy orders the continuous order book presently contains, and/or (ii) the continuous order book determining whether to decrease the current strike price (or market price) to encourage buy orders based at least in part on how many unmatched sell orders the continuous order book presently contains.

After determining that the current strike price should be increased to encourage sell orders, some embodiments of method 1200 include the continuous order book increasing the current strike price (or market price in some embodiments) based on one or more of (i) the current strike price, (ii) a strike price from a third party, (iii) how many unmatched continuous buy orders are in the continuous order book, (iv) when the continuous order book includes unmatched limit buy orders, how many unmatched limit buy orders are in the continuous order book and a corresponding strike price of each unmatched limit buy order, wherein a limit buy order is a bet that the outcome of the event will be above a corresponding strike price for the limit buy order, and wherein the limit buy order is treated as a continuous buy order as long as the current strike price is less than the corresponding strike price for the limit buy order, (v) when the continuous order book includes unmatched limit sell orders, how many unmatched limit sell orders are in the continuous order book and a corresponding strike price for each unmatched limit sell order, wherein a limit sell order is a bet that the outcome of the event will be below a corresponding strike price for the limit sell order, and wherein the limit sell order is treated as a continuous sell order as long as the current strike price is less than the corresponding strike price for the limit sell order, (vi) how many unique bettors have unmatched bets in the order book, (vii) a rate at which the order book is receiving bets from bettors, (viii) a rate at which buy orders are being matched with sell orders, (ix) a fixed constant over time, and/or (x) a percentage of the current strike price.

For example, in some scenarios, the continuous order book is configured to increase the current strike price (or market price in some embodiments) when the volume of unmatched buy orders exceeds the volume of unmatched sell orders. In another example, the continuous order book increases the current strike price (or market price in some embodiments) when the volume of unmatched buy orders exceeds the volume of unmatched sell orders by some threshold amount. In some embodiments, the threshold amount may be an absolute amount or a threshold ratio of unmatched sell orders to unmatched buy orders.

Similarly, after determining that the current strike price should be decreased to encourage buy orders, some embodiments of method 1200 include the continuous order book decreasing the current strike price (or market price in some embodiments) based on one or more of (i) the current strike price, (ii) the strike price from the third party, (iii) how many unmatched continuous buy orders are in the order book, (iv) when the order book includes unmatched limit buy orders, how many unmatched limit buy orders are in the order book and a corresponding strike price of each unmatched limit buy order, (v) when the order book includes unmatched limit sell orders, how many unmatched limit sell orders are in the order book and a corresponding strike price for each unmatched limit sell order, (vi) how many unique bettors have unmatched bets in the order book, (vii) the rate at which the order book is receiving bets from bettors, (viii) the rate at which buy orders are being matched with sell orders, (ix) the fixed constant over time, and/or (x) the percentage of the current strike price.

For example, in some scenarios, the continuous order book decreases the current strike price (or market price in some embodiments) when the volume of unmatched sell orders exceeds the volume of unmatched buy orders. In another example, the continuous order book decreases the current strike price (or market price in some embodiments) when the volume of unmatched sell orders exceeds the volume of unmatched buy orders by some threshold amount. In some embodiments, the threshold amount may be an absolute amount or a threshold ratio of unmatched sell orders to unmatched buy orders

In some embodiments, method 1200 additionally includes the continuous order book receiving information relating to an external strike price from a third party. In such embodiments, method 1200 additionally includes the continuous order book performing several features in scenarios when the current strike price (or market price) differs by more than a threshold amount from the external strike price (or market price) received from the third party, including the continuous order book (i) cancelling all unmatched continuous buy orders and unmatched continuous sell orders in the continuous order book, and (ii) resetting the current strike price in the continuous order book based on the external strike price received from the third party. After the continuous order book has canceled the unmatched orders and reset the current strike price, some embodiments additionally include the continuous order book providing a fixed duration of time for (i) all buyers to cancel their existing limit buy orders in the order book and (ii) all sellers to cancel their existing limit sell orders in the order book. And then after the fixed duration of time, some embodiments further include the continuous order book beginning to accept new buy orders and new sell orders again.

In accordance with various embodiments of the present disclosure, one or more aspects of the methods described herein are intended for operation as software programs and/or components thereof running on one or more computer processors. Furthermore, software implementations can include, but are not limited to, distributed processing or component/object distributed processing, parallel processing, and/or virtual machine processing, any one of which (or combination thereof) can also be used to implement the methods described herein.

The present disclosure contemplates a tangible, non-transitory machine-readable medium containing instructions so that a device connected to the communications network 135, another network, or a combination thereof, can send or receive voice, video or data, and communicate over the communications network 135, another network, or a combination thereof, using the instructions. The instructions may further be transmitted or received over the communications network 135, another network, or a combination thereof, via the network interface device.

While the machine-readable medium is shown in an example embodiment to be a single medium, the term “machine-readable medium” or “machine-readable media” should be taken to include a single medium or multiple media (e.g., a centralized or distributed database, and/or associated caches and servers) that store the one or more sets of instructions. The term “machine-readable medium” or “machine-readable media” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A method of operating an order book, the method comprising:
providing a current market price for an item, wherein the current market price is configured to change over time, wherein the order book is configured for matching orders to buy the item with orders to sell the item;
receiving a continuous buy order for the item;
after receiving the continuous buy order for the item, determining whether the order book contains a suitable sell order to match with the received continuous buy order, wherein a continuous buy order is an offer to purchase the item at any market price advertised by the order book;
when the order book contains a suitable sell order to match with the received continuous buy order, matching the received continuous buy order with the suitable sell order;
when the order book does not contain a suitable sell order to match with the received continuous buy order, (i) storing the received continuous buy order in the order book for matching with a suitable sell order in the future and (ii) considering the stored received continuous buy order when determining whether to increase the current market price of the item to encourage sell orders;
receiving a continuous sell order;
after receiving a continuous sell order, determining whether the order book contains a suitable buy order to match with the received continuous sell order, wherein a continuous sell order is an offer to sell the item at any market price advertised by the order book;
when the order book contains a suitable buy order to match with the received continuous sell order, matching the received continuous sell order with the suitable buy order; and
when the order book does not contain a suitable buy order to match with the received continuous sell order, (i) storing the received continuous sell order in the order book for matching with a suitable buy order in the future and (ii) considering the stored received continuous sell order when determining whether to decrease the current market price of the item to encourage buy orders.

2. The method of claim 1, wherein the item comprises at least one of (i) an equity, (ii) a debt, (iii) a currency, (iv) a commodity, (v) a swap, (vi) an option on an outcome of an event, wherein the option comprises one of (a) a bet that the outcome will occur or (b) a bet that the outcome will not occur, or (vii) a derivative that is not an option on the outcome of an event.

3. The method of claim 2, wherein:
when the item is a binary option that the outcome will occur, each buy order matched with a corresponding sell order creates a contract between a buyer and seller, wherein the contract has a purchase price based on the current market price at the time the buy order is matched with the sell order and a payout amount, and wherein the contract (i) obligates the buyer to pay the purchase price into an escrow account for the contract, (ii) obligates the seller to pay the payout amount into the escrow account for the contract, (iii) pays the amount in the escrow account for the contract to the buyer if the outcome occurs, and (iv) pays the amount in the escrow account for the contract to the seller if the outcome does not occur; and
when the item is a binary option that the outcome will not occur, each buy order matched with a corresponding sell order creates a contract between the buyer and seller, wherein the contract has a purchase price based on the current market price at the time the buy order is matched with the sell order and a payout amount, and wherein the contract (i) obligates the buyer to pay the purchase price into an escrow account for the contract, (ii) obligates the seller to pay the payout amount to into the escrow account for the contract, (iii) pays the amount in the escrow account for the contract to the buyer if the outcome does not occur, and (iv) pays the amount in the escrow account for the contract to the seller if the outcome occurs.

4. The method of claim 1, further comprising:
determining whether to increase the current market price of the item to encourage sell orders based on how many unmatched buy orders the order book presently contains; and
determining whether to decrease the current market price of the item to encourage buy orders based on how many unmatched sell orders the order book presently contains.

5. The method of claim 4, further comprising:
after determining that the current market price of the item should be increased to encourage sell orders, increasing the current market price of the item based on one or more of (i) the current market price of the item, (ii) a price of the item received from a third party, (iii) how many unmatched continuous buy orders are in the order book, (iv) when the order book includes unmatched limit buy orders, how many unmatched limit buy orders are in the order book and a corresponding price of each unmatched limit buy order, wherein a limit buy order is a buy order that is treated as a continuous buy order as long as the current market price is less than or equal to the corresponding limit price of the limit buy order, (v) when the order book includes unmatched limit sell orders, how many unmatched limit sell orders are in the order book and a corresponding price of each unmatched limit sell order, wherein a limit sell order is a sell order that is treated as a continuous sell order as long as the current market price is greater than or equal to the corresponding limit price of the limit sell order, (vi) how many unique buyers and sellers have unmatched orders in the order book, (vii) a rate at which the order book is receiving orders, (viii) a rate at which buy orders are being matched with sell orders, (ix) a fixed constant over time, and/or (x) a percentage of the current market price; and
after determining that the current market price of the item should be decreased to encourage buy orders, decreasing the current market price of the item based on one or more of (i) the current market price of the item, (ii) the price of the item received from the third party, (iii) how many unmatched continuous sell orders are in the order book, (iv) when the order book includes unmatched limit buy orders, how many unmatched limit buy orders are in the order book and a corresponding price of each unmatched limit buy order, (v) when the order book includes unmatched limit sell orders, how many unmatched limit sell orders are in the order book and a corresponding price of each unmatched limit sell order, (vi) how many unique buyers and sellers have unmatched orders in the order book, (vii) the rate at which the order book is receiving orders, (viii) the rate at which buy orders are being matched with sell orders, (ix) the fixed constant over time, and/or (x) the percentage of the current market price.

6. The method of claim 1, further comprising, after increasing the current market price of the item or decreasing the current market price of the item:
determining whether the order book contains a suitable sell order to match with any previously-stored buy order; and
determining whether the order book contains a suitable buy order to match with any previously-stored sell order.

7. The method of claim 1, wherein determining whether the order book contains a suitable sell order to match with the received continuous buy order comprises determining whether the order book contains at least one of (i) a continuous sell order to match with the received continuous buy order or (ii) a limit sell order at a limit price that is less than or equal to the current market price for the item, wherein a limit sell order is a sell order that is treated as a continuous sell order as long as the current market price is greater than or equal to the corresponding limit price of the limit sell order; and
wherein determining whether the order book contains a suitable buy order to match with the received continuous sell order comprises determining whether the order book contains at least one of (i) a continuous buy order to match with the received continuous sell order or (ii) a limit buy order at a limit price that is greater than or equal to the current market price for the item, wherein a limit buy order is a buy order that is treated as a continuous buy order as long as the current market price is less than or equal to the corresponding limit price of the limit buy order.

8. The method of claim 1, further comprising:
for a limit buy order having a corresponding limit price, (i) when the current market price is greater than the corresponding limit price for the limit buy order, storing the limit buy order in the order book for matching with a suitable sell order in the future, and (ii) when the current market price is less than or equal to the corresponding limit price for the limit buy order, matching the limit buy order with a continuous sell order in the order book as long as the current market price is less than or equal to the limit price of the limit buy order; and
for a limit sell order having a corresponding limit price, (i) when the current market price is less than the corresponding limit price for the limit sell order, storing the limit sell order in the order book for matching with a suitable buy order in the future, and (ii) when the current market price is greater than or equal to the corresponding limit price for the limit sell order, matching the limit sell order with a continuous buy order in the order book as long as the current market price is greater than or equal to the limit price of the limit sell order.

9. The method of claim 1, wherein:
an individual buy order includes an indication of whether the buy order should be (i) matched with a suitable sell order via the order book as soon as possible or (ii) matched with a suitable sell order via the order book after a delay period, wherein the buy order may be cancelled during the delay period; and
an individual sell order includes an indication of whether the sell order should be (i) matched with a suitable buy order via the order book as soon as possible or (ii) matched with a suitable buy order via the order book after a delay period, wherein the sell order may be cancelled during the delay period.

10. The method of claim 1, wherein:
when a total quantity of continuous buy orders received from a plurality of buyers exceeds a total quantity of suitable sell orders for matching with the continuous buy orders, allocating the total quantity of suitable sell orders to the plurality of buyers pro rata to each buyer according to a quantity of continuous buy orders received from the buyer divided by the total quantity of continuous buy orders received from the plurality of buyers; and
when a total quantity of continuous sell orders received from a plurality of sellers exceeds a total quantity of suitable buy orders for matching with the continuous sell orders, allocating the total quantity of suitable buy orders to the plurality of sellers pro rata to each seller according to a quantity of continuous sell orders received from the seller divided by the total quantity of continuous sell orders received from the plurality of sellers.

11. The method of claim 1, further comprising, when the current market price for the item differs by more than a threshold amount from a price of the item received from a third party:
cancelling all unmatched continuous buy orders and unmatched continuous sell orders in the order book;
resetting the current market price in the order book based on the price received from the third party;
providing a fixed duration of time for all buyers to cancel their existing limit buy orders in the order book and all sellers to cancel their existing limit sell orders in the order book; and
after the fixed duration of time, begin accepting new buy orders for the item and new sell orders for the item again.

12. A method of operating an order book, the method comprising:
maintaining a current strike price for a fixed-price bet on an outcome of an event, wherein the current strike price is configured to change over time, wherein the order book is configured for matching buy orders with sell orders, wherein a buy order is a bet that the outcome of the event occurs in such a way that a measurement of interest will be above the strike price, and wherein a sell order is a bet that the outcome of the event occurs in such a way that the measurement of interest will be below the strike price;
receiving a continuous buy order;
after receiving the continuous buy order, determining whether the order book contains a suitable sell order to match with the received continuous buy order, wherein a continuous buy order is a bet that the outcome of the event will be above any strike price advertised by the order book;
when the order book contains a suitable sell order to match with the received continuous buy order, matching the received continuous buy order with the suitable sell order;
when the order book does not contain a suitable sell order to match with the received continuous buy order, (i) storing the received continuous buy order in the order book for matching with a suitable sell order in the future and (ii) considering the received continuous buy order when determining whether to increase the current strike price to encourage sell orders;
receiving a continuous sell order;
after receiving the continuous sell order, determining whether the order book contains a suitable buy order to match with the received continuous sell order, wherein a continuous sell order is a bet that the outcome of the event will be below any strike price advertised by the order book;
when the order book contains a suitable buy order to match with the received continuous sell order, matching the received continuous sell order with the suitable buy order; and
when the order book does not contain a suitable buy order to match with the received continuous sell order, (i) storing the received continuous sell order in the order book for matching with a suitable buy order in the future and (ii) considering the received continuous sell order when determining whether to decrease the current strike price to encourage buy orders.

13. The method of claim 12, wherein each buy order received from a buyer matched with a corresponding sell order received from a seller creates a contract between the buyer and the seller, wherein the contract has an strike price based on the current strike price at the time the buy order is matched with the sell order and a payout price, wherein the contract (i) obligates the buyer to pay the payout price to the seller when the outcome is below the strike price for the contract and (ii) obligates the seller to pay the payout price to the buyer when the outcome is above the strike price for the contract.

14. The method of claim 12, further comprising, after increasing the strike price for the bet or decreasing the current strike price for the bet:
determining whether the order book contains a suitable sell order to match with any previously-stored buy order; and
determining whether the order book contains a suitable buy order to match with any previously-stored sell order.

15. The method of claim 12, further comprising:
determining whether to increase the current strike price to encourage sell orders is based on how many unmatched buy orders the order book presently contains; and
determining whether to decrease the current strike price to encourage sell orders is based on how many unmatched buy orders the order book presently contains.

16. The method of claim 15, further comprising:
after determining that the current strike price should be increased to encourage sell orders, increasing the current strike price based on one or more of (i) the current strike price, (ii) a strike price from a third party, (iii) how many unmatched continuous buy orders are in the order book, (iv) when the order book includes unmatched limit buy orders, how many unmatched limit buy orders are in the order book and a corresponding strike price of each unmatched limit buy order, wherein a limit buy order is a bet that the outcome of the event will be above a corresponding strike price for the limit buy order, and wherein the limit buy order is treated as a continuous buy order as long as the current strike price is less than the corresponding strike price for the limit buy order, (v) when the order book includes unmatched limit sell orders, how many unmatched limit sell orders are in the order book and a corresponding strike price for each unmatched limit sell order, wherein a limit sell order is a bet that the outcome of the event will be below a corresponding strike price for the limit sell order, and wherein the limit sell order is treated as a continuous sell order as long as the current strike price is less than the corresponding strike price for the limit sell order, (vi) how many unique bettors have unmatched bets in the order book, (vii) a rate at which the order book is receiving bets from bettors, (viii) a rate at which buy orders are being matched with sell orders, (ix) a fixed constant over time, and/or (x) a percentage of the current strike price; and
after determining that the current strike price should be increased to encourage sell orders, increasing the current strike price based on one or more of (i) the current strike price, (ii) the strike price from the third party, (iii) how many unmatched continuous buy orders are in the order book, (iv) when the order book includes unmatched limit buy orders, how many unmatched limit buy orders are in the order book and a corresponding strike price of each unmatched limit buy order, (v) when the order book includes unmatched limit sell orders, how many unmatched limit sell orders are in the order book and a corresponding strike price for each unmatched limit sell order, (vi) how many unique bettors have unmatched bets in the order book, (vii) the rate at which the order book is receiving bets from bettors, (viii) the rate at which buy orders are being matched with sell orders, (ix) the fixed constant over time, and/or (x) the percentage of the current strike price.

17. The method of claim 12, wherein:
determining whether the order book contains a suitable sell order to match with the received continuous buy order comprises determining whether the order book contains at least one of (i) a continuous sell order to match with the received continuous buy order or (ii) a limit sell order having a corresponding strike price that is below the current strike price, wherein a limit sell order is a bet that the outcome of the event will be below the corresponding strike price for the limit sell order, and wherein the limit sell order is treated as a continuous sell order as long as the current strike price is greater than the corresponding strike price for the limit sell order; and
determining whether the order book contains a suitable buy order to match with the received continuous sell order comprises determining whether the order book contains at least one of (i) a continuous buy order to match with the received continuous sell order or (ii) a limit buy order having a corresponding strike price that is above the current strike price, wherein a limit buy order is a bet that the outcome of the event will be above the corresponding strike price for the limit buy order, and wherein the limit buy order is treated as a continuous buy order as long as the current strike price is less than the corresponding strike price for the limit buy order.

18. The method of claim 12, further comprising:
for a limit buy order having a corresponding strike price: (i) when the current strike price is less than the corresponding strike price for the limit buy order, matching the limit buy order with a continuous sell order in the order book as long as the current strike price is less than the corresponding strike price of the limit buy order, and (ii) when the current strike price is greater than the corresponding strike price for the limit buy order, storing the limit buy order in the order book for matching with a suitable sell order in the future; and
for a limit sell order having a corresponding strike price: (i) when the current strike price is greater than the corresponding strike price for the limit sell order, matching the limit sell order with a continuous buy order in the order book as long as the current strike price is greater than the corresponding strike price of the limit sell order, and (ii) when the current strike price is less than the corresponding strike price for the limit sell order, storing the limit sell order in the order book for matching with a suitable buy order in the future.

19. The method of claim 12, wherein:
an individual buy order includes an indication of whether the buy order should be (i) matched with a suitable sell order via the order book as soon as possible or (ii) matched with a suitable sell order via the order book after a delay period, wherein the buy order may be cancelled during the delay period; and
an individual sell order includes an indication of whether the sell order should be (i) matched with a suitable buy order via the order book as soon as possible or (ii) matched with a suitable buy order via the order book after a delay period, wherein the sell order may be cancelled during the delay period.

20. The method of claim 12, wherein:
when a total quantity of continuous buy orders received from a plurality of buyers exceeds a total quantity of suitable sell orders for matching with the continuous buy orders, allocating the total quantity of suitable sell orders to the plurality of buyers pro rata to each buyer according to a quantity of continuous buy orders received from the buyer divided by the total quantity of continuous buy orders received from the plurality of buyers; and
when a total quantity of continuous sell orders received from a plurality of sellers exceeds a total quantity of suitable buy orders for matching with the continuous sell orders, allocating the total quantity of suitable buy orders to the plurality of sellers pro rata to each seller according to a quantity of continuous sell orders received from the seller divided by the total quantity of continuous sell orders received from the plurality of sellers.
